(19) United States
(12) Patent Application Publication
(10) Pub. No.: US 2026/0046750 A1
(43) Pub. Date: Feb. 12, 2026

(54) SYNCHRONIZATION RASTER FOR CHANNEL CO-EXISTENCE

(71) Applicant: QUALCOMM Incorporated, San Diego, CA (US)

(72) Inventors: Toni Harri Henrikki LAEHTEENSUO, Helsinki (FI); Changhwan PARK, San Diego, CA (US); Le LIU, San Jose, CA (US); Timo Ville VINTOLA, San Diego, CA (US)

(21) Appl. No.: 18/796,836

(22) Filed: Aug. 7, 2024

(51) Int. Cl. H04W 48/16

(52) U.S. Cl. CPC H04W 48/16

(57) ABSTRACT

Various aspects of the present disclosure generally relate to wireless communication. In some aspects, a network entity may perform, in accordance with a synchronization raster, a search operation associated with a cell, wherein the synchronization raster indicates an unequal frequency domain spacing between groups of raster points of the synchronization raster. The network entity may receive, based on the search operation, one or more synchronization signal blocks (SSBs) associated with the cell. Numerous other aspects are described.

### FIELD OF THE DISCLOSURE

Aspects of the present disclosure generally relate to wireless communication and specifically relate to techniques, apparatuses, and methods associated with a synchronization raster for channel co-existence.

### INTRODUCTION

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a network entity includes a processing system configured to: perform, in accordance with a synchronization raster, a search operation associated with a cell, wherein the synchronization raster indicates an unequal frequency domain spacing between groups of raster points of the synchronization raster; and receive, based on the search operation, one or more synchronization signal blocks (SSBs) associated with the cell.

In some aspects, a network entity includes a processing system configured to: transmit, in accordance with a synchronization raster, one or more SSBs associated with a cell, wherein the synchronization raster indicates an unequal frequency domain spacing between groups of raster points of the synchronization raster; and receive one or more communications associated with the one or more SSBs.

In some aspects, a method of wireless communication performed by a network entity includes performing, in accordance with a synchronization raster, a search operation associated with a cell, wherein the synchronization raster indicates an unequal frequency domain spacing between groups of raster points of the synchronization raster; and receiving, based on the search operation, one or more SSBs associated with the cell.

In some aspects, a method of wireless communication performed by a network entity includes transmitting, in accordance with a synchronization raster, one or more SSBs associated with a cell, wherein the synchronization raster indicates an unequal frequency domain spacing between groups of raster points of the synchronization raster; and receiving one or more communications associated with the one or more SSBs.

In some aspects, a non-transitory computer-readable medium having instructions for wireless communication stored thereon that, when executed by one or more processors of a network entity, cause the network entity to: perform, in accordance with a synchronization raster, a search operation associated with a cell, wherein the synchronization raster indicates an unequal frequency domain spacing between groups of raster points of the synchronization raster; and receive, based on the search operation, one or more SSBs associated with the cell.

In some aspects, a non-transitory computer-readable medium having instructions for wireless communication stored thereon that, when executed by one or more processors of a network entity, cause the network entity to: transmit, in accordance with a synchronization raster, one or more SSBs associated with a cell, wherein the synchronization raster indicates an unequal frequency domain spacing between groups of raster points of the synchronization raster; and receive one or more communications associated with the one or more SSBs.

In some aspects, an apparatus for wireless communication includes means for performing, in accordance with a synchronization raster, a search operation associated with a cell, wherein the synchronization raster indicates an unequal frequency domain spacing between groups of raster points of the synchronization raster; and means for receiving, based on the search operation, one or more SSBs associated with the cell.

In some aspects, an apparatus for wireless communication includes means for transmitting, in accordance with a synchronization raster, one or more SSBs associated with a cell, wherein the synchronization raster indicates an unequal frequency domain spacing between groups of raster points of the synchronization raster; and means for receiving one or more communications associated with the one or more SSBs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example network node in communication with an example user equipment (UE) in a wireless network, in accordance with the present disclosure.

FIG. 4 is a diagram illustrating an example disaggregated base station architecture, in accordance with the present disclosure.

FIGS. 5A and 5B are diagrams illustrating examples associated with a synchronization raster, in accordance with the present disclosure.

FIG. 6 is a diagram illustrating an example of a regenerative satellite deployment and an example of a transparent satellite deployment in a non-terrestrial network, in accordance with the present disclosure.

FIG. 7 is a diagram of an example associated with a synchronization raster for channel co-existence, in accordance with the present disclosure.

FIG. 8 is a diagram of an example associated with a synchronization raster having punctured raster points, in accordance with the present disclosure.

FIGS. 9A and 9B are diagrams of an example associated with a synchronization raster having unequal frequency domain spacing, in accordance with the present disclosure.

FIG. 10 is a diagram illustrating an example process performed, for example, at a network entity or an apparatus of a network entity, in accordance with the present disclosure.

FIG. 11 is a diagram illustrating an example process performed, for example, at a network entity or an apparatus of a network entity, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

In some examples, a user equipment (UE) may scan one or more frequencies for synchronization signal blocks (SSBs) transmitted by a network node. An SSB may be used by the UE for system acquisition. An SSB may include a primary synchronization signal (PSS), a secondary synchronization signal (SSS), a physical broadcast channel (PBCH) communication, and/or the like. Synchronization signals (e.g., PSSs and/or SSSs) may be transmitted at particular frequency locations that are defined by a synchronization raster. A raster may define a set of raster points. As used herein, “raster point” refers to a reference frequency for a channel or signal. For example, a synchronization raster point may indicate a reference frequency (e.g., a center frequency) for an SSB. A synchronization raster may indicate the frequency positions of the SSB when explicit signaling of the SSB position is not present. For example, a synchronization raster may refer to an index of frequency locations. For example, in a band associated with a frequency f, possible frequency locations for sending synchronization signals may include f+Nd, where d is the value of the synchronization raster and N is an integer. Each frequency location may be used, for example, as a synchronization raster hypothesis. A synchronization raster hypothesis is a candidate (e.g., potential) frequency index associated with a synchronization raster that may be associated with a synchronization signal.

The synchronization raster design for some synchronization rasters is too sparse to enable SSB detection in channels having narrow transmission bandwidths (e.g., 3 megahertz (MHz) channels, 5 MHz channels with less than 5 MHz of transmission bandwidth) for any location within the existing channel raster. Furthermore, a 1200 kilohertz (kHz) frequency window employed by some synchronization raster designs may cause an SSB (e.g., an SSB having a bandwidth of 20 resource blocks) to at least partially fall outside of a narrow transmission bandwidth.

A second synchronization raster design may provide or define additional synchronization raster points. The second synchronization raster design may improve the likelihood of SSB detection in channels having narrow transmission bandwidths by providing or defining the additional synchronization raster points. The second synchronization raster design may be associated with a 600 kHz frequency window (e.g., as compared to the 1200 kHz frequency window), providing additional synchronization raster points within a given bandwidth.

Each synchronization raster may define groups of raster points within a frequency window (e.g., clusters of raster points). A frequency spacing between consecutive (e.g., in the frequency domain) groups of raster points may be equal. For example, for the first synchronization raster, the frequency spacing may be 1200 kHz (e.g., the frequency window for the first synchronization raster is 1200 kHz). For the second synchronization raster, the frequency spacing may be 600 kHz (e.g., the frequency window for the second synchronization raster is 600 kHz). The frequency spacing between consecutive raster points in the frequency domain may be 100 kHz. In some cases, a frequency spacing between a first raster point defined by the first synchronization raster and a second raster point defined by the second synchronization raster may be 100 kHz.

However, in some examples, the introduction of the second synchronization raster may cause SSB detection or cell identification errors. For example, in high Doppler scenarios and/or in high mobility scenarios, the UE may experience frequency errors or frequency drift in received signals. As an example, in non-terrestrial network (NTN) deployments, a feeder link and a service link may each experience Doppler effects due to the movement of the satellites, and potentially movement of the UE. These Doppler effects may be significantly larger than in a terrestrial network. The Doppler effect on the feeder link may be compensated for to some degree, but may still be associated with some amount of uncompensated frequency error. Furthermore, a gateway may be associated with a residual frequency error, and/or the satellite may be associated with an on-board frequency error. These sources of frequency error may cause a received downlink frequency at the UE to drift from a target downlink frequency.

The frequency error or frequency drift of signals received by the UE may result in ambiguity as to which synchronization raster point is observed or detected by the UE. For example, the frequency error (e.g., a Doppler shift) experienced by the UE in NTN deployments may be in the order of 50 kHz or more. As described elsewhere herein, a frequency spacing between raster points of different frequency rasters may be as small as 100 kHz. As a result, the frequency error or frequency drift of synchronization signals received by the UE may cause the UE to incorrectly determine that a given synchronization raster point is observed or detected. As an example, a first cell (e.g., a first terrestrial network cell or a first NTN cell that uses a first synchronization raster) and second cell (e.g., a second terrestrial network cell or a second NTN cell that uses a second synchronization raster) are deployed or operate in overlapping frequencies in the same geographical area. The UE may intend to search for the second cell or the first cell. However, because of the frequency error or frequency drift of synchronization signals received by the UE, the UE may incorrectly select a raster point to scan or measure to access the intended cell (e.g., in some cases, raster points for the first cell and the second cell may be separated by 100 kHz and the UE may experience frequency error or frequency drift on the order of 50 kHz, increasing the likelihood of the UE selecting the wrong raster point to scan and/or measure). This may result in the UE consuming power resources, network resources, and/or time resources, among other examples, associated with scanning, measuring, and/or attempting to access the wrong cell (e.g., an unintended cell). This may increase latency associated with the UE accessing the intended cell.

Although examples may be described herein associated with NTN deployments resulting in frequency error or frequency drift of signals received by the UE, the UE may similarly experience frequency error or frequency drift in other network deployments or scenarios. For example, the problems described herein may similarly occur in other high Doppler or high mobility scenarios (e.g., where the UE or a network node is moving at a high rate of speed), such as high-speed train scenarios, aircraft scenarios (e.g., where the UE 220 is located on, or is included in, an aircraft), maritime or naval scenarios, and/or unmanned ariel vehicle (UAV) scenarios (e.g., where the UE is located on, or is included in, a UAV or drone), among other examples.

Various aspects relate generally to a synchronization raster for channel co-existence. Some aspects more specifically relate to a synchronization raster design that increases frequency spacing between raster points associated with different synchronization rasters. In some aspects, the synchronization raster may indicate an unequal frequency domain spacing between groups of raster points of the synchronization raster. For example, the frequency spacing between consecutive (e.g., in the frequency domain) of groups (e.g., clusters) of raster points defined by the synchronization raster may be unequal or different. In some aspects, the synchronization raster may be associated with multiple frequency windows. Additionally, or alternatively, the frequency window for the synchronization raster may include multiple groups (e.g., clusters) of raster points. As an example, the synchronization raster may be associated with a frequency window that includes two groups (e.g., clusters) of raster points (e.g., rather than a single group or cluster of raster points).

In some aspects, the synchronization raster may be associated with multiple offset values for defining the frequency domain location of a group of raster points. For example, for a first value of a parameter (e.g., even values of the parameter N), the synchronization raster may be associated with a first offset value. For a second value of a parameter (e.g., odd values of the parameter N), the synchronization raster may be associated with a second offset value. This results in the unequal or non-constant frequency domain spacing between groups (e.g., clusters) of raster points defined by the synchronization raster. In some aspects, the multiple offset values may be defined by an integer factor of a subcarrier size.

Additionally, or alternatively, a first synchronization raster may include one or more punctured raster points (e.g., a punctured raster point may be a raster point that is defined by the synchronization raster, but that is not scanned or measured (e.g., is ignored) by a UE). The one or more punctured raster points may correspond to raster points of a second synchronization raster. For example, the one or more punctured raster points may be raster points that are closest to (e.g., in the frequency domain) raster points of the second synchronization raster.

Particular aspects of the subject matter described in this disclosure can be implemented to realize one or more of the following potential advantages. In some examples, by defining a synchronization raster that increases the frequency spacing between raster points associated with different synchronization rasters, the described techniques can be used to increase the likelihood of a UE correctly selecting a raster point to scan or measure to access an intended cell. For example, the unequal frequency domain spacing between groups of raster points of the synchronization raster may enable a group of raster points to be placed (e.g., in the frequency domain) further than raster point(s) of another synchronization raster. Additionally, or alternatively, by the UE puncturing one or more raster points that are closest to the raster point(s) of another synchronization raster, the frequency spacing between raster points defined by different synchronization raster may be increased. The increased frequency spacing may increase the likelihood of the UE selecting and/or monitoring a raster point for a cell that the UE intends to access, thereby conserving power resources and/or network resources that would have otherwise been associated with the UE selecting and/or monitoring a raster point for an unintended cell. Improving the likelihood of the UE selecting and/or monitoring a raster point for a cell that the UE intends to access may reduce latency associated with access the cell.

In some aspects, by offset values of the synchronization raster being defined by an integer factor of a subcarrier size, the likelihood of all radio frequency (RF) channel positions (e.g., defined by a channel raster) remaining usable is increased. For example, by shifting an offset value of the synchronization raster by an integer factor of a subcarrier size, the likelihood that the closest raster point from a next group of raster points can be used when an RF channel changes is increased.

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, RF chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems are presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

Multiple-access RATs have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, NTN deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, RF sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

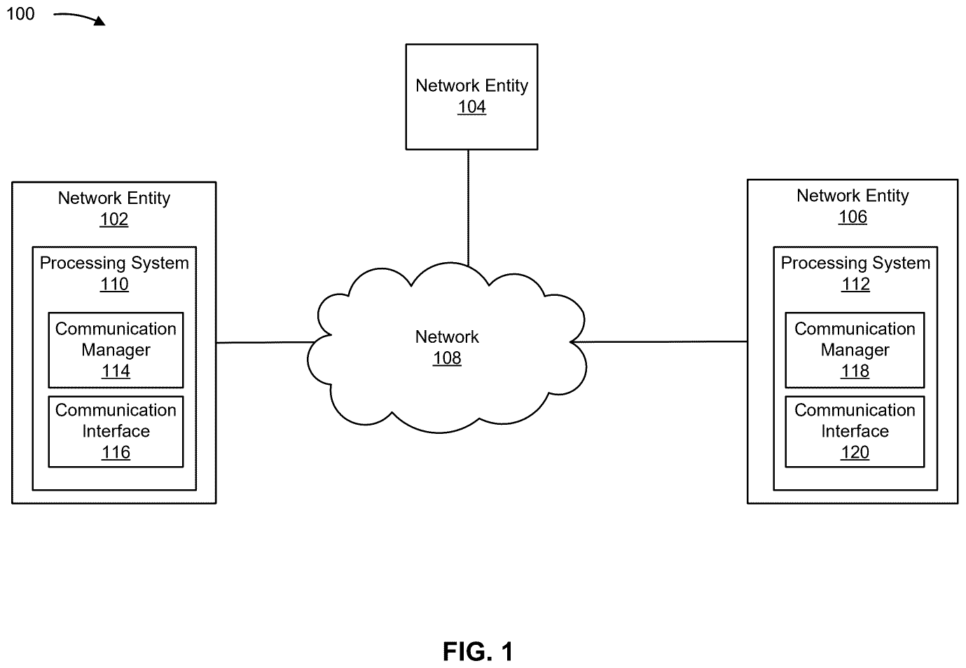

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

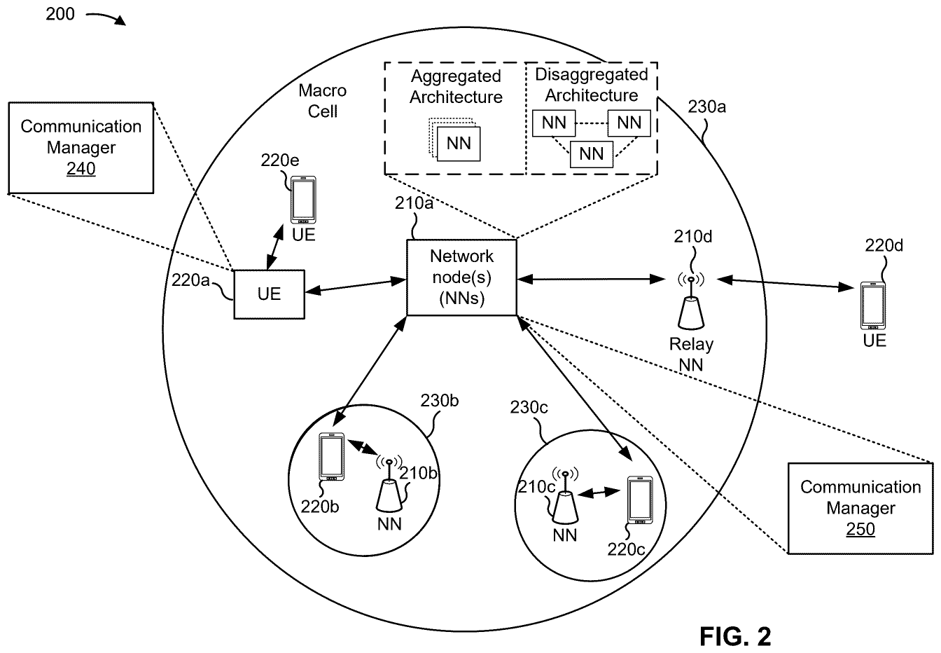

The network 108 may include, for example, a cellular network (e.g., a Long-Term Evolution (LTE) network, a code division multiple access (CDMA) network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a RedCap device, an enhanced reduced capability (eRedCap) device, an IoT device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I2C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) perform, in accordance with a synchronization raster, a search operation associated with a cell, wherein the synchronization raster indicates an unequal frequency domain spacing between groups of raster points of the synchronization raster; and/or receive, based on the search operation, one or more SSBs associated with the cell. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) transmit, in accordance with a synchronization raster, one or more SSBs associated with a cell, wherein the synchronization raster indicates an unequal frequency domain spacing between groups of raster points of the synchronization raster; and/or receive one or more communications associated with the one or more SSBs. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210, shown as a network node (NN) 210a, a network node 210b, a network node 210c, and a network node 210d. The network nodes 210 may support communications with multiple UEs 220, shown as a UE 220a, a UE 220b, a UE 220c, a UE 220d, and a UE 220c.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 200 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 210 may include one or more devices, components, or systems that enable communication between a UE 220 and one or more devices, components, or systems of the wireless communication network 200. A network node 210 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 210 may be implemented as a single physical node (for example, a single physical structure) or may be implemented as two or more physical nodes (for example, two or more distinct physical structures). For example, a network node 210 may be a device or system that implements part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node (having an aggregated architecture), meaning that the network node 210 may implement a full radio protocol stack that is physically and logically integrated within a single node (for example, a single physical structure) in the wireless communication network 200. For example, an aggregated network node 210 may consist of a single standalone base station or a single TRP that uses a full radio protocol stack to enable or facilitate communication between a UE 220 and a core network of the wireless communication network 200.

Alternatively, and as also shown, a network node 210 may be a disaggregated network node (sometimes referred to as a disaggregated base station), meaning that the network node 210 may implement a radio protocol stack that is physically distributed and/or logically distributed among two or more nodes in the same geographic location or in different geographic locations. For example, a disaggregated network node may have a disaggregated architecture. In some deployments, disaggregated network nodes 210 may be used in an IAB network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 210 of the wireless communication network 200 may include one or more CUs, one or more DUs, and/or one or more RUs. A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 220, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 220.

In some aspects, a single network node 210 may include a combination of one or more CUs, one or more DUs, and/or one or more RUs. Additionally or alternatively, a network node 210 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 210 (for example, a base station, an RU, or a TRP) may provide communication coverage for a particular geographic area. In the 3GPP, the term “cell” can refer to a coverage area of a network node 210 or to a network node 210 itself, depending on the context in which the term is used. A network node 210 may support one or multiple (for example, three) cells. In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with service subscriptions. A pico cell may cover a relatively small geographic area and may allow unrestricted access by UEs 220 with service subscriptions. A femto cell may cover a relatively small geographic area (for example, a home) and may allow restricted access by UEs 220 having association with the femto cell (for example, UEs 220 in a closed subscriber group (CSG)). A network node 210 for a macro cell may be referred to as a macro network node. A network node 210 for a pico cell may be referred to as a pico network node. A network node 210 for a femto cell may be referred to as a femto network node or an in-home network node. In some examples, a cell may not necessarily be stationary. For example, the geographic area of the cell may move according to the location of an associated mobile network node 210 (for example, a train, a satellite base station, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. In the example shown in FIG. 1, the network node 210a may be a macro network node for a macro cell 230a, the network node 210b may be a pico network node for a pico cell 230b, and the network node 210c may be a femto network node for a femto cell 230c. Various different types of network nodes 210 may generally transmit at different power levels, serve different coverage areas, and/or have different impacts on interference in the wireless communication network 200 than other types of network nodes 210. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink channels may include one or more control channels and one or more data channels. A downlink control channel may be used to transmit downlink control information (DCI) (for example, scheduling information, reference signals, and/or configuration information) from a network node 210 to a UE 220. A downlink data channel may be used to transmit downlink data (for example, user data associated with a UE 220) from a network node 210 to a UE 220. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 220 to a network node 210. An uplink data channel may be used to transmit uplink data (for example, user data associated with a UE 220) from a UE 220 to a network node 210. Uplink control channels may include one or more physical uplink control channels (PUCCHs), and uplink data channels may include one or more physical uplink shared channels (PUSCHs). The downlink and the uplink may each include a set of resources on which the network node 210 and the UE 220 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into BWPs. A BWP may be a block of frequency domain resources (for example, a block of resource blocks) that are allocated for one or more UEs 220. A UE 220 may be configured with both an uplink BWP and a downlink BWP (where the uplink BWP and the downlink BWP may be the same BWP or different BWPs). A BWP may be dynamically configured (for example, by a network node 210 transmitting a DCI configuration to the one or more UEs 220) and/or reconfigured, which means that a BWP can be adjusted in real-time (or near-real-time) based on changing network conditions in the wireless communication network 200 and/or based on the specific requirements of the one or more UEs 220. This enables more efficient use of the available frequency domain resources in the wireless communication network 200 because fewer frequency domain resources may be allocated to a BWP for a UE 220 (which may reduce the quantity of frequency domain resources that a UE 220 is required to monitor), leaving more frequency domain resources to be spread across multiple UEs 220. Thus, BWPs may also assist in the implementation of lower-capability UEs 220 by facilitating the configuration of smaller bandwidths for communication by such UEs 220.

As indicated above, a BWP may be configured as a subset or a part of a total or full component carrier bandwidth and generally forms or encompasses a set of common resource blocks (CRBs) within the full component carrier bandwidth. In other words, within the carrier bandwidth, a BWP starts at a CRB and may span a set of CRBs. Each BWP may be associated with its own numerology (indicating a sub-carrier spacing (SCS) and cyclic prefix (CP)). A UE 220 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 220 within the operating bandwidth of the serving cell while all other BWPs with which the UE 220 is configured are deactivated. On deactivated BWPs, the UE 220 does not transmit or receive any communications.

As described above, in some aspects, the wireless communication network 200 may be, may include, or may be included in, an IAB network. In an IAB network, at least one network node 210 is an anchor network node that communicates with a core network. An anchor network node 210 may also be referred to as an IAB donor (or “IAB-donor”). The anchor network node 210 may connect to the core network via a wired backhaul link. For example, an Ng interface of the anchor network node 210 may terminate at the core network. Additionally or alternatively, an anchor network node 210 may connect to one or more devices of the core network that provide a core access and mobility management function (AMF). An IAB network also generally includes multiple non-anchor network nodes 210, which may also be referred to as relay network nodes or simply as IAB nodes (or “IAB-nodes”). Each non-anchor network node 210 may communicate directly with the anchor network node 210 via a wireless backhaul link to access the core network, or may communicate indirectly with the anchor network node 210 via one or more other non-anchor network nodes 210 and associated wireless backhaul links that form a backhaul path to the core network. Some anchor network node 210 or other non-anchor network node 210 may also communicate directly with one or more UEs 220 via wireless access links that carry access traffic. In some examples, network resources for wireless communication (such as time resources, frequency resources, and/or spatial resources) may be shared between access links and backhaul links.

In some examples, any network node 210 that relays communications may be referred to as a relay network node, a relay station, or simply as a relay. A relay may receive a transmission of a communication from an upstream station (for example, another network node 210 or a UE 220) and transmit the communication to a downstream station (for example, a UE 220 or another network node 210). In this case, the wireless communication network 200 may include or be referred to as a “multi-hop network.” In the example shown in FIG. 1, the network node 210d (for example, a relay network node) may communicate with the network node 210a (for example, a macro network node) and the UE 220d in order to facilitate communication between the network node 210a and the UE 220d. Additionally or alternatively, a UE 220 may be or may operate as a relay station that can relay transmissions to or from other UEs 220. A UE 220 that relays communications may be referred to as a UE relay or a relay UE, among other examples.

The UEs 220 may be physically dispersed throughout the wireless communication network 200, and each UE 220 may be stationary or mobile. A UE 220 may be, may include, or may be included in an access terminal, another terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 220 and/or a network node 210 may include one or more chips, system-on-chips (SoCs), chipsets, packages, or devices that individually or collectively constitute or comprise a processing system (such as the processing system 110 and/or the processing system 112). The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 220 may include or may be included in a housing that houses components associated with the UE 220 including the processing system.

Some UEs 220 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an unmanned aerial vehicle or drone, a remote device, a sensor, a meter, a monitor, and/or a location tag. Some UEs 220 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 220 may be considered Customer Premises Equipment, which may include telecommunications devices that are installed at a customer location (such as a home or office) to enable access to a service provider's network (such as included in or in communication with the wireless communication network 200).

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between UEs 220 of the first category and UEs 220 of the second capability). A UE 220 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 220 (for example, shown as UE 220a and UE 220c) may communicate directly with one another using sidelink communications (for example, without communicating by way of a network node 210 as an intermediary). As an example, the UE 220a may directly transmit data, control information, or other signaling as a sidelink communication to the UE 220c. This is in contrast to, for example, the UE 220a first transmitting data in an UL communication to a network node 210, which then transmits the data to the UE 220e in a DL communication. In various examples, the UEs 220 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 210 may schedule and/or allocate resources for sidelink communications between UEs 220 in the wireless communication network 200. In some other deployments and configurations, a UE 220 (instead of a network node 210) may perform, or collaborate or negotiate with one or more other UEs to perform, scheduling operations, resource selection operations, and/or other operations for sidelink communications.

In various examples, some of the network nodes 210 and the UEs 220 of the wireless communication network 200 may be configured for full-duplex operation in addition to half-duplex operation. A network node 210 or a UE 220 operating in a half-duplex mode may perform only one of transmission or reception during particular time resources, such as during particular slots, symbols, or other time periods. Half-duplex operation may involve time-division duplexing (TDD), in which DL transmissions of the network node 210 and UL transmissions of the UE 220 do not occur in the same time resources (that is, the transmissions do not overlap in time). In contrast, a network node 210 or a UE 220 operating in a full-duplex mode can transmit and receive communications concurrently (for example, in the same time resources). By operating in a full-duplex mode, network nodes 210 and/or UEs 220 may generally increase the capacity of the network and the radio access link. In some examples, full-duplex operation may involve frequency-division duplexing (FDD), in which DL transmissions of the network node 210 are performed in a first frequency band or on a first component carrier and transmissions of the UE 220 are performed in a second frequency band or on a second component carrier different than the first frequency band or the first component carrier, respectively. In some examples, full-duplex operation may be enabled for a UE 220 but not for a network node 210. For example, a UE 220 may simultaneously transmit an UL transmission to a first network node 210 and receive a DL transmission from a second network node 210 in the same time resources. In some other examples, full-duplex operation may be enabled for a network node 210 but not for a UE 220. For example, a network node 210 may simultaneously transmit a DL transmission to a first UE 220 and receive an UL transmission from a second UE 220 in the same time resources. In some other examples, full-duplex operation may be enabled for both a network node 210 and a UE 220.

In some examples, the UEs 220 and the network nodes 210 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

The network node 210 may provide the UE 220 with a configuration of transmission configuration indicator (TCI) states that indicate or correspond to beams that may be used by the UE 220, such as for receiving one or more communications via a physical channel. For example, the network node 210 may indicate (for example, using DCI) an activated TCI state to the UE 220, which the UE 220 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or a sounding reference signal (SRS) set ID, among other examples. A TCI state information element (sometimes referred to as a TCI state herein) may indicate particular information associated with a beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, or a ql-TypeD, among other examples), a cell identification (for example, a ServCellIndex), a bandwidth part identification (bwp-Id), or a reference signal identification, such as a channel state information (CSI) reference signal (CSI-RS) identification (for example, an NZP-CSI-RS-Resourceld or an SSB-Index, among other examples). Spatial relation information may similarly indicate information associated with an uplink beam. The beam indication may be a joint or separate DL/UL beam indication in a unified TCI framework. In a unified TCI framework, a network node 210 may support common TCI state ID update and activation, which may provide common QCL and/or common UL transmission spatial filters across a set of configured component carriers. This type of beam indication may apply to intra-band carrier aggregation, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some aspects, the UE 220 may include a communication manager 240. As described in more detail elsewhere herein, the communication manager 240 may perform, in accordance with a synchronization raster, a search operation associated with a cell, wherein the synchronization raster indicates an unequal frequency domain spacing between groups of raster points of the synchronization raster; and/or receive, based on the search operation, one or more SSBs associated with the cell. Additionally, or alternatively, the communication manager 240 may perform one or more other operations described herein.

In some aspects, the network node 210 may include a communication manager 150. As described in more detail elsewhere herein, the communication manager 250 may transmit, in accordance with a synchronization raster, one or more SSBs associated with a cell, wherein the synchronization raster indicates an unequal frequency domain spacing between groups of raster points of the synchronization raster; and/or receive one or more communications associated with the one or more SSBs. Additionally, or alternatively, the communication manager 250 may perform one or more other operations described herein.

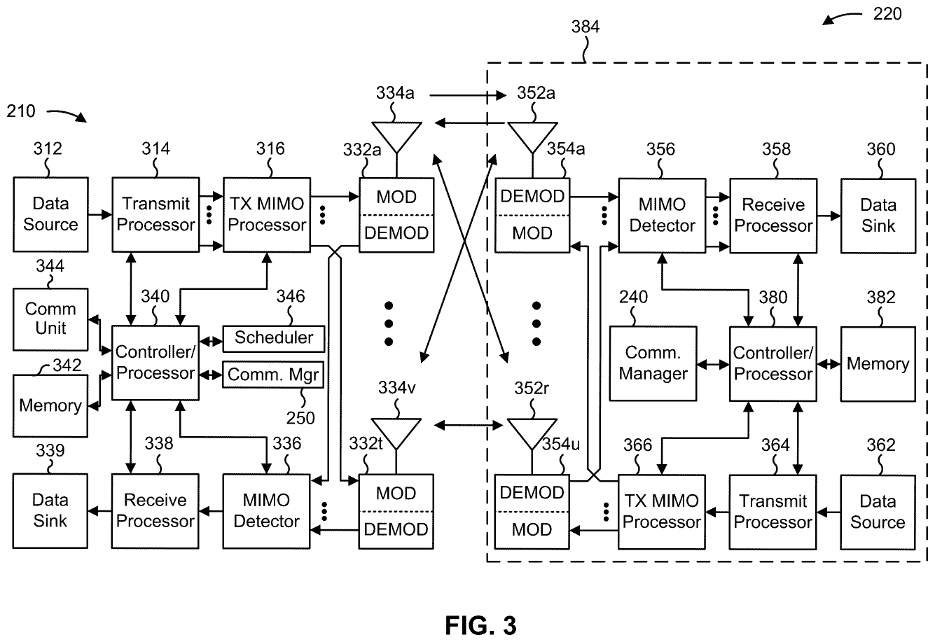

FIG. 3 is a diagram illustrating an example network node 210 in communication with an example UE 220 in a wireless network, in accordance with the present disclosure.

As shown in FIG. 3, the network node 210 may include a data source 312, a transmit processor 314, a transmit (TX) MIMO processor 316, a set of modems 332 (shown as 332a through 332t, where t≥1), a set of antennas 334 (shown as 334a through 334v, where v≥1), a MIMO detector 336, a receive processor 338, a data sink 339, a controller/processor 340, a memory 342, a communication unit 344, a scheduler 346, and/or a communication manager 250, among other examples. In some configurations, one or a combination of the antenna(s) 334, the modem(s) 332, the MIMO detector 336, the receive processor 338, the transmit processor 314, and/or the TX MIMO processor 316 may be included in a transceiver of the network node 210. The transceiver may be under control of and used by one or more processors, such as the controller/processor 340, and in some aspects in conjunction with processor-readable code stored in the memory 342, to perform aspects of the methods, processes, and/or operations described herein. In some aspects, the network node 210 may include one or more interfaces, communication components, and/or other components that facilitate communication with the UE 220 or another network node.

The terms “processor,” “controller,” or “controller/processor” may refer to one or more controllers and/or one or more processors. For example, reference to “a/the processor,” “a/the controller/processor,” or the like (in the singular) refers to any one or more of the processors described in connection with FIG. 3, such as a single processor or a combination of multiple different processors. Reference to “one or more processors” refers to any one or more of the processors described in connection with FIG. 3. For example, one or more processors of the network node 210 may include transmit processor 314, TX MIMO processor 316, MIMO detector 336, receive processor 338, and/or controller/processor 340. Similarly, one or more processors of the UE 220 may include MIMO detector 356, receive processor 358, transmit processor 364, TX MIMO processor 366, and/or controller/processor 380.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” refers to any one or more memories of a corresponding device, such as the memory described in connection with FIG. 3. For example, operation described as being performed by one or more memories can be performed by the same subset of the one or more memories or different subsets of the one or more memories.

For downlink communication from the network node 210 to the UE 220, the transmit processor 314 may receive data (“downlink data”) intended for the UE 220 (or a set of UEs that includes the UE 220) from the data source 312 (such as a data pipeline or a data queue). In some examples, the transmit processor 314 may select one or more modulation and coding schemes (MCSs) for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 314 may process system information (for example, semi-static resource partitioning information (SRPI)) and/or control information (for example, CQI requests, grants, and/or upper layer signaling) and provide overhead symbols and/or control symbols. The transmit processor 314 may generate reference symbols for reference signals (for example, a cell-specific reference signal (CRS), a demodulation reference signal (DMRS), or a CSI-RS) and/or synchronization signals (for example, a PSS or an SSS).

The TX MIMO processor 316 may perform spatial processing (for example, precoding) on the data symbols, the control symbols, the overhead symbols, and/or the reference symbols, if applicable, and may provide a set of output symbol streams (for example, T output symbol streams) to the set of modems 332. For example, each output symbol stream may be provided to a respective modulator component (shown as MOD) of a modem 332. Each modem 332 may use the respective modulator component to process (for example, to modulate) a respective output symbol stream (for example, for orthogonal frequency division multiplexing (OFDM)) to obtain an output sample stream. Each modem 332 may further use the respective modulator component to process (for example, convert to analog, amplify, filter, and/or upconvert) the output sample stream to obtain a time domain downlink signal. The modems 332a through 332t may together transmit a set of downlink signals (for example, T downlink signals) via the corresponding set of antennas 334.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 200. A data stream (for example, from the data source 312) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 334, may be processed by a modem 332 (for example, a demodulator component, shown as DEMOD, of a modem 332), may be detected by the MIMO detector 336 (for example, a receive (Rx) MIMO processor) if applicable, and/or may be further processed by the receive processor 338 to obtain decoded data and/or control information. The receive processor 338 may provide the decoded data to a data sink 339 (which may be a data pipeline, a data queue, and/or another type of data sink) and provide the decoded control information to a processor, such as the controller/processor 340.

The network node 210 may use the scheduler 346 to schedule one or more UEs 220 for downlink or uplink communications. In some aspects, the scheduler 346 may use DCI to dynamically schedule DL transmissions to the UE 220 and/or UL transmissions from the UE 220. In some examples, the scheduler 346 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 314, the TX MIMO processor 316, the modem 332, the antenna 334, the MIMO detector 336, the receive processor 338, and/or the controller/processor 340 may be included in an RF chain of the network node 210. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 210). In some aspects, the RF chain may be or may be included in a transceiver of the network node 210.

In some examples, the network node 210 may use the communication unit 344 to communicate with a core network and/or with other network nodes. The communication unit 344 may support wired and/or wireless communication protocols and/or connections, such as Ethernet, optical fiber, common public radio interface (CPRI), and/or a wired or wireless backhaul, among other examples. The network node 210 may use the communication unit 344 to transmit and/or receive data associated with the UE 220 or to perform network control signaling, among other examples. The communication unit 344 may include a transceiver and/or an interface, such as a network interface.

The UE 220 may include a set of antennas 352 (shown as antennas 352a through 352r, where r≥1), a set of modems 354 (shown as modems 354a through 354u, where u≥1), a MIMO detector 356, a receive processor 358, a data sink 360, a data source 362, a transmit processor 364, a TX MIMO processor 366, a controller/processor 380, a memory 382, and/or a communication manager 240, among other examples. One or more of the components of the UE 220 may be included in a housing 384. In some aspects, one or a combination of the antenna(s) 352, the modem(s) 354, the MIMO detector 356, the receive processor 358, the transmit processor 364, or the TX MIMO processor 366 may be included in a transceiver that is included in the UE 220. The transceiver may be under control of and used by one or more processors, such as the controller/processor 380, and in some aspects in conjunction with processor-readable code stored in the memory 382, to perform aspects of the methods, processes, or operations described herein. In some aspects, the UE 220 may include another interface, another communication component, and/or another component that facilitates communication with the network node 210 and/or another UE 220.

For downlink communication from the network node 210 to the UE 220, the set of antennas 352 may receive the downlink communications or signals from the network node 210 and may provide a set of received downlink signals (for example, R received signals) to the set of modems 354. For example, each received signal may be provided to a respective demodulator component (shown as DEMOD) of a modem 354. Each modem 354 may use the respective demodulator component to condition (for example, filter, amplify, downconvert, and/or digitize) a received signal to obtain input samples. Each modem 354 may use the respective demodulator component to further demodulate or process the input samples (for example, for OFDM) to obtain received symbols. The MIMO detector 356 may obtain received symbols from the set of modems 354, may perform MIMO detection on the received symbols if applicable, and may provide detected symbols. The receive processor 358 may process (for example, decode) the detected symbols, may provide decoded data for the UE 220 to the data sink 360 (which may include a data pipeline, a data queue, and/or an application executed on the UE 220), and may provide decoded control information and system information to the controller/processor 380.

For uplink communication from the UE 220 to the network node 210, the transmit processor 364 may receive and process data (“uplink data”) from a data source 362 (such as a data pipeline, a data queue, and/or an application executed on the UE 220) and control information from the controller/processor 380. The control information may include one or more parameters, feedback, one or more signal measurements, and/or other types of control information. In some aspects, the receive processor 358 and/or the controller/processor 380 may determine, for a received signal (such as received from the network node 210 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 220 by the network node 210.

The transmit processor 364 may generate reference symbols for one or more reference signals, such as an uplink DMRS, an uplink SRS, and/or another type of reference signal. The symbols from the transmit processor 364 may be precoded by the TX MIMO processor 366, if applicable, and further processed by the set of modems 354 (for example, for DFT-s-OFDM or CP-OFDM). The TX MIMO processor 366 may perform spatial processing (for example, precoding) on the data symbols, the control symbols, the overhead symbols, and/or the reference symbols, if applicable, and may provide a set of output symbol streams (for example, U output symbol streams) to the set of modems 354. For example, each output symbol stream may be provided to a respective modulator component (shown as MOD) of a modem 354. Each modem 354 may use the respective modulator component to process (for example, to modulate) a respective output symbol stream (for example, for OFDM) to obtain an output sample stream. Each modem 354 may further use the respective modulator component to process (for example, convert to analog, amplify, filter, and/or upconvert) the output sample stream to obtain an uplink signal.

The modems 354a through 354u may transmit a set of uplink signals (for example, R uplink signals or U uplink symbols) via the corresponding set of antennas 352. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 220) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 352 or the set of antennas 334 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 334 or an antenna 352 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 210 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

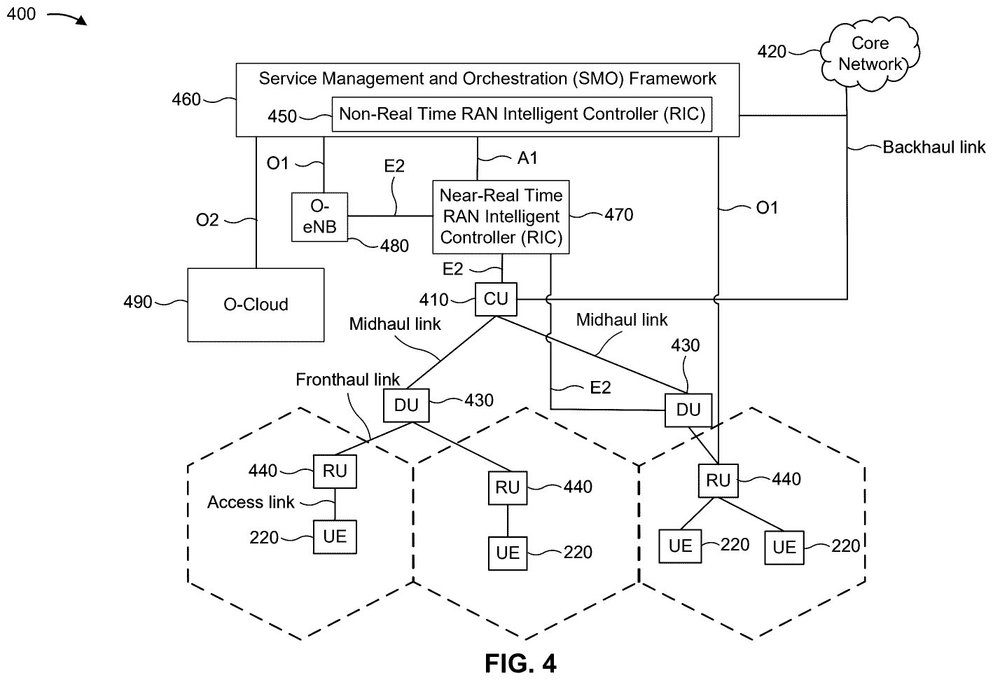

FIG. 4 is a diagram illustrating an example disaggregated base station architecture 400, in accordance with the present disclosure. One or more components of the example disaggregated base station architecture 400 may be, may include, or may be included in one or more network nodes (such one or more network nodes 210). The disaggregated base station architecture 400 may include a CU 410 that can communicate directly with a core network 420 via a backhaul link, or that can communicate indirectly with the core network 420 via one or more disaggregated control units, such as a Non-RT RIC 450 associated with a Service Management and Orchestration (SMO) Framework 460 and/or a Near-RT RIC 470 (for example, via an E2 link). The CU 410 may communicate with one or more DUs 430 via respective midhaul links, such as via F1 interfaces. Each of the DUs 430 may communicate with one or more RUs 440 via respective fronthaul links. Each of the RUs 440 may communicate with one or more UEs 220 via respective RF access links. In some deployments, a UE 220 may be simultaneously served by multiple RUs 440.

Each of the components of the disaggregated base station architecture 400, including the CUs 410, the DUs 430, the RUs 440, the Near-RT RICs 470, the Non-RT RICs 450, and the SMO Framework 460, may include one or more interfaces or may be coupled with one or more interfaces for receiving or transmitting signals, such as data or information, via a wired or wireless transmission medium.

In some aspects, the CU 410 may be logically split into one or more CU-UP units and one or more CU-CP units. A CU-UP unit may communicate bidirectionally with a CU-CP unit via an interface, such as the E1 interface when implemented in an O-RAN configuration. The CU 410 may be deployed to communicate with one or more DUs 430, as necessary, for network control and signaling. Each DU 430 may correspond to a logical unit that includes one or more base station functions to control the operation of one or more RUs 440. For example, a DU 430 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 430, or for communicating signals with the control functions hosted by the CU 410. Each RU 440 may implement lower layer functionality. In some aspects, real-time and non-real-time aspects of control and user plane communication with the RU(s) 440 may be controlled by the corresponding DU 430.

The SMO Framework 460 may support RAN deployment and provisioning of non-virtualized and virtualized network elements. For non-virtualized network elements, the SMO Framework 460 may support the deployment of dedicated physical resources for RAN coverage requirements, which may be managed via an operations and maintenance interface, such as an O1 interface. For virtualized network elements, the SMO Framework 460 may interact with a cloud computing platform (such as an open cloud (O-Cloud) platform 490) to perform network element life cycle management (such as to instantiate virtualized network elements) via a cloud computing platform interface, such as an O2 interface. A virtualized network element may include, but is not limited to, a CU 410, a DU 430, an RU 440, a non-RT RIC 450, and/or a Near-RT RIC 470. In some aspects, the SMO Framework 460 may communicate with a hardware aspect of a 4G RAN, a 5G NR RAN, and/or a 6G RAN, such as an open eNB (O-eNB) 480, via an O1 interface. Additionally or alternatively, the SMO Framework 460 may communicate directly with each of one or more RUs 440 via a respective O1 interface. In some deployments, this configuration can enable each DU 430 and the CU 410 to be implemented in a cloud-based RAN architecture, such as a vRAN architecture.

The Non-RT RIC 450 may include or may implement a logical function that enables non-real-time control and optimization of RAN elements and resources, AI/ML workflows including model training and updates, and/or policy-based guidance of applications and/or features in the Near-RT RIC 470. The Non-RT RIC 450 may be coupled to or may communicate with (such as via an A1 interface) the Near-RT RIC 470. The Near-RT RIC 470 may include or may implement a logical function that enables near-real-time control and optimization of RAN elements and resources via data collection and actions via an interface (such as via an E2 interface) connecting one or more CUs 410, one or more DUs 430, and/or an O-eNB with the Near-RT RIC 470.

In some aspects, to generate AI/ML models to be deployed in the Near-RT RIC 470, the Non-RT RIC 450 may receive parameters or external enrichment information from external servers. Such information may be utilized by the Near-RT RIC 470 and may be received at the SMO Framework 460 or the Non-RT RIC 450 from non-network data sources or from network functions. In some examples, the Non-RT RIC 450 or the Near-RT RIC 470 may tune RAN behavior or performance. For example, the Non-RT RIC 450 may monitor long-term trends and patterns for performance and may employ AI/ML models to perform corrective actions via the SMO Framework 460 (such as reconfiguration via an O1 interface) or via creation of RAN management policies (such as A1 interface policies).

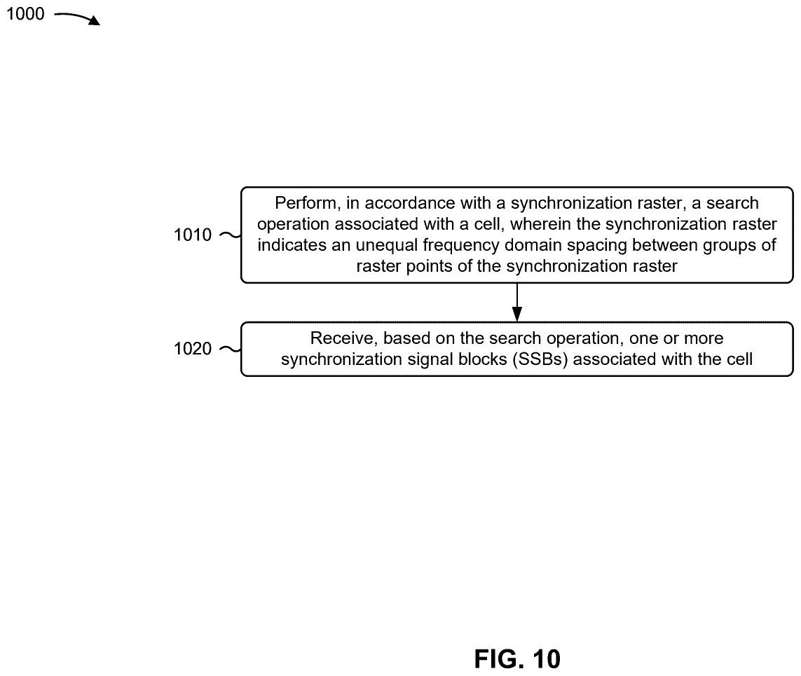

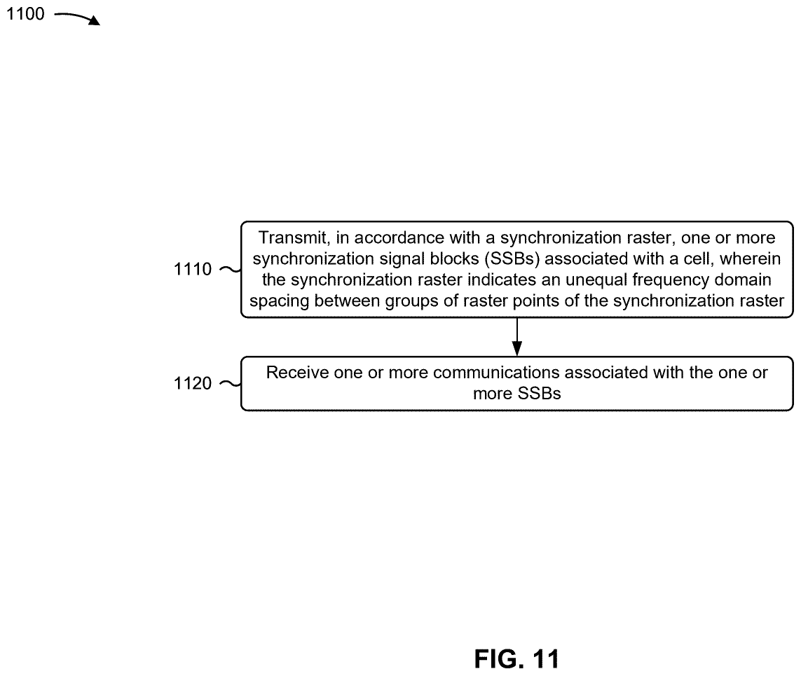

The network node 210, the controller/processor 340 of the network node 210, the UE 220, the controller/processor 380 of the UE 220, the CU 410, the DU 430, the RU 440, or any other component(s) of FIG. 1, 2, 3 or 4 may implement one or more techniques or perform one or more operations associated with a synchronization raster for channel co-existence, as described in more detail elsewhere herein. For example, the controller/processor 340 of the network node 210, the controller/processor 380 of the UE 220, any other component(s) of FIG. 3, the CU 410, the DU 430, or the RU 440 may perform or direct operations of, for example, process 1000 of FIG. 10, process 1100 of FIG. 11, or other processes as described herein (alone or in conjunction with one or more other processors). The memory 342 may store data and program codes for the network node 210, the network node 210, the CU 410, the DU 430, or the RU 440. The memory 382 may store data and program codes for the UE 220. In some examples, the memory 342 or the memory 382 may include a non-transitory computer-readable medium storing a set of instructions (for example, code or program code) for wireless communication. The memory 342 may include one or more memories, such as a single memory or multiple different memories (of the same type or of different types). The memory 382 may include one or more memories, such as a single memory or multiple different memories (of the same type or of different types). For example, the set of instructions, when executed (for example, directly, or after compiling, converting, or interpreting) by one or more processors of the network node 210, the UE 220, the CU 410, the DU 430, or the RU 440, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 220 includes means for performing, in accordance with a synchronization raster, a search operation associated with a cell, wherein the synchronization raster indicates an unequal frequency domain spacing between groups of raster points of the synchronization raster; and/or means for receiving, based on the search operation, one or more SSBs associated with the cell. The means for the UE to perform operations described herein may include, for example, one or more of communication manager 240, antenna 352, modem 354, MIMO detector 356, receive processor 358, transmit processor 364, TX MIMO processor 366, controller/processor 380, or memory 382.

In some aspects, the network node 210 includes means for transmitting, in accordance with a synchronization raster, one or more SSBs associated with a cell, wherein the synchronization raster indicates an unequal frequency domain spacing between groups of raster points of the synchronization raster; and/or means for receiving one or more communications associated with the one or more SSBs. The means for the network node 210 to perform operations described herein may include, for example, one or more of communication manager 250, transmit processor 314, TX MIMO processor 316, modem 332, antenna 334, MIMO detector 336, receive processor 338, controller/processor 340, memory 342, or scheduler 346.

In a wireless communication network, a UE 220 may scan one or more frequencies for SSBs transmitted by the network node 210. An SSB may be used by the UE 220 for system acquisition. An SSB may include a PSS, an SSS, a PBCH communication, and/or the like. In some aspects, the PBCH communication may include remaining minimum system information (RMSI), such as an RMSI control resource set (CORESET) configuration and/or the like, which may be used by the UE 220 to determine a random access channel (RACH) configuration for performing a RACH procedure for initial access to the network node 210.

Synchronization signals (e.g., PSSs and/or SSSs) may be transmitted at particular frequency locations that are defined by a synchronization raster. A raster may define a set of raster points. As used herein, “raster point” refers to a reference frequency for a channel or signal. For example, a synchronization raster point may indicate a reference frequency (e.g., a center frequency) for an SSB. A synchronization raster may indicate the frequency positions of the SSB when explicit signaling of the SSB position is not present. For example, a synchronization raster may refer to an index of frequency locations. For example, in a band associated with a frequency f, possible frequency locations for sending synchronization signals may include f+Nd, where d is the value of the synchronization raster and Nis an integer. Each frequency location may be used, for example, as a synchronization raster hypothesis. A synchronization raster hypothesis is a candidate (e.g., potential) frequency index associated with a synchronization raster that may be associated with a synchronization signal.

The NR physical layer may be modified to operate in spectrum allocations from approximately 3 MHz up to 5 MHz. Transmissions may be restricted to a subcarrier spacing of 15 kHz and the use of a normal cyclic prefix. For the SSB, PSS/SSS specifications may be re-used without puncturing, and the PBCH may be based on existing designs. For functional support, changes may be made to the PDCCH, the CSI-RS, the tracking reference signal (TRS), the PUCCH, and/or the PRACH.

The NR physical layer may be modified to operate in spectrum allocations from approximately 3 MHz up to 5 MHz including in operating bands n26, n28, n85, n100, n106, n254, n255, and/or n256, among other examples. System parameters (including channel rasters and synchronization rasters) may be specified for the associated spectrum.

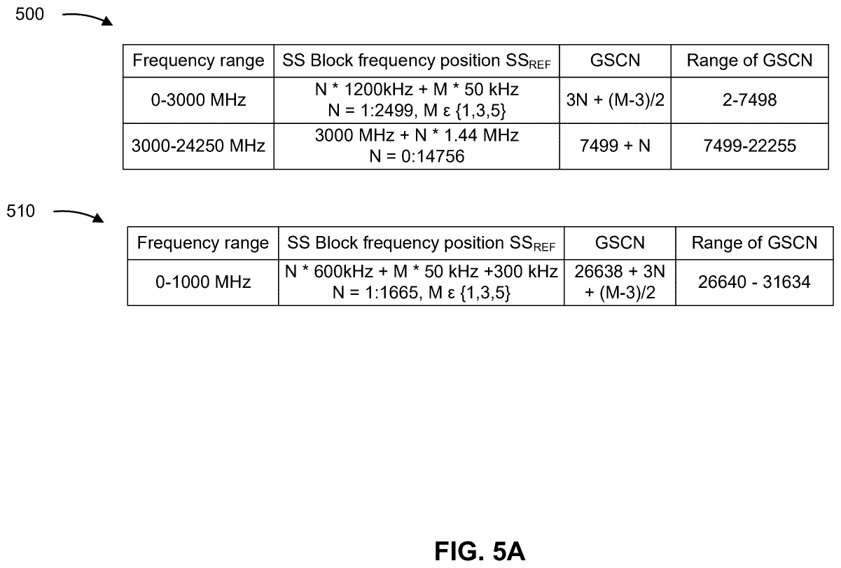

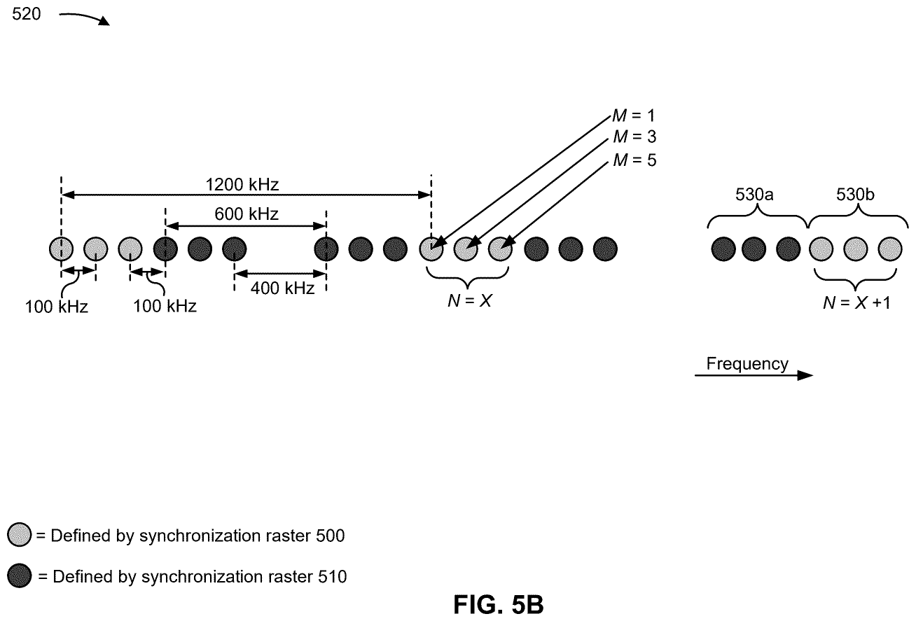

FIGS. 5A and 5B are diagrams illustrating examples associated with a synchronization raster, in accordance with the present disclosure. FIG. 5A depicts tables for defining a first synchronization raster 500 and a second synchronization raster 510. In some examples, the first synchronization raster 500 may be associated with a first channel bandwidth and the second synchronization raster 510 may be associated with a second channel bandwidth. As an example, the table associated with the first synchronization raster 500 may define global synchronization channel number (GSCN) parameters for a global frequency raster for above 3 MHz channel bandwidth and the table associated with the second synchronization raster 510 may define GSCN parameters for a global frequency raster for a 3 MHz channel bandwidth.

The first synchronization raster 500 relates to a synchronization raster and associated numbering. For example, the table associated with the first synchronization raster 500 indicates GSCN parameters for a global frequency raster. The global synchronization raster may be defined for multiple (e.g., all) frequencies, and the frequency position of the SSB may be defined as SS_{REF}. As shown in the table associated with the first synchronization raster 500, various parameters may define the SS_{REF} and GSCN for the multiple frequency ranges. The synchronization raster and the subcarrier spacing of the SSB may be defined separately for each band.

As shown, some frequency ranges (e.g., 0 to 3000 MHz), an SSB may be transmitted at one or more frequency positions within a frequency window (e.g., three potential frequency positions with 100 kHz spacing within a frequency window of 1200 kHz, which may be indicated as N*1200+M*50 kHz, where N=1:2499 and M=1, 3, 5). This frequency window may be referred to as a synchronization raster cluster or a group of raster points, and may indicate multiple possible frequency positions for SSBs (e.g., multiple SS_{REF}s). Each S_{SREF} may have a corresponding GSCN, which may be used for identifying an S_{SREF} using less overhead.

In some examples, a channel raster may be similarly defined by a table. For example, the table may relate to the NR absolute RF channel number (NR-ARFCN) and channel raster (e.g., a global frequency channel raster). The table may indicate NR-ARFCN parameters for the global channel raster. The global channel raster may define a set of RF reference frequencies F_{REF}. The F_{REF} may be used in signaling to identify the position of RF channels, SSBs, or the like. The global channel raster may be defined for all frequencies from 0 to 100 GHz. The granularity of the global frequency raster may be ΔF_{Global}. F_{REF} may be designated by the NR-ARFCN in the range 0-2016666 on the global channel raster. The relationship between the NR-ARFCN and the F_{REF} in MHz may be given by F_{REF}=F_{REF-Offs}+ΔF_{Global} (N_{REF}−N_{REF-Offs}), where N_{REF} may be the NR-ARFCN and F_{REF-Offs} and N_{REF-Offs} may be defined in the table.

The channel raster may define a subset of F_{REF}s that may be used to identify the RF channel position in the uplink and downlink. The F_{REF} for an RF channel may map to a resource element on the carrier. For each operating band, a subset of frequencies from the global channel raster may apply to that operating band and form a channel raster with a granularity ΔF_{Raster}, which may be equal to or larger than ΔF_{Global}.

In some examples, for NR operating bands with 100 kHz channel rasters, ΔF_{Raster}=20×ΔF_{Global}. As a result, every twentieth NR-ARFCN within the operating band may apply to the channel raster within the operating band. As further shown, the step size for the channel raster may be <20>. Thus, while the channel raster may be specified with a 5 kHz step size for the full 0-3000 MHz range, the channel raster that applies to the operating band provided in the table may be 100 KHz.

The synchronization raster design for the first synchronization raster 500 is too sparse to enable SSB detection in channels having narrow transmission bandwidths (e.g., 3 MHz channels, 5 MHz channels with less than 5 MHz of transmission bandwidth, or the like) for any location within the existing channel raster. Furthermore, the 1200 KHz frequency window employed by synchronization raster design for the first synchronization raster 500 may cause an SSB (e.g., an SSB having a bandwidth of 20 resource blocks) to at least partially fall outside of a narrow transmission bandwidth.

The second synchronization raster 510 may provide or define additional synchronization raster points. The second synchronization raster 510 may improve the likelihood of SSB detection in channels having narrow transmission bandwidths by providing or defining the additional synchronization raster points. As shown in FIG. 5A, the table associated with the second synchronization raster 510 indicates GSCN parameters for a global frequency raster. The global synchronization raster may be defined for multiple (e.g., all) frequencies, and the frequency position of the SSB may be defined as S_{SREF}. As shown in the table associated with the second synchronization raster 510, various parameters may define the S_{SREF} and GSCN for the multiple frequency ranges. The synchronization raster and the subcarrier spacing of the SSB may be defined separately for each band. The second synchronization raster 510 may be associated with a 600 KHz frequency window (e.g., as compared to the 1200 kHz frequency window employed by synchronization raster design for the first synchronization raster 500).

As shown in FIG. 5B, the first synchronization raster 500 and the second synchronization raster 510 define synchronization raster points 520 (shown as the shaded circles in FIG. 5B). Each synchronization raster may define groups 530 of raster points within a frequency window. FIG. 5B shows a group 530a of raster points associated with the second synchronization raster 510 and a group 530b of raster points associated with the first synchronization raster 500 as example groups 530. A group 530 of raster points may also be referred to as a cluster of raster points. The frequency window for the first synchronization raster 500 is 1200 kHz and the frequency window for the second synchronization raster 510 is 600 kHz. As described herein, parameters (e.g., N and M) may define a given raster point. For example, as shown in FIG. 5B and for the first synchronization raster 500, a value of the parameter N may indicate during which frequency window (e.g., in which group 530 of raster points) the given raster point occurs (e.g., a value of X may indicate a first frequency window and a value of X+1 may indicate the next frequency in the frequency domain). A value of the parameter M may indicate the given raster point among one or more raster points within the frequency window (e.g., within the group 530 of raster points indicated by the value of N).

As shown in FIG. 5B, a frequency spacing between consecutive (e.g., in the frequency domain) groups 530 may be equal. For example, for the first synchronization raster 500, the frequency spacing may be 1200 kHz (e.g., the frequency window for the first synchronization raster 500 is 1200 kHz). For the second synchronization raster 510, the frequency spacing may be 600 kHz (e.g., the frequency window for the second synchronization raster 510 is 600 kHz). The frequency spacing between consecutive raster points in the frequency domain may be 100 kHz. As shown in FIG. 5B, in some cases, a frequency spacing between a first raster point defined by the first synchronization raster 500 and a second raster point defined by the second synchronization raster 510 may be 100 kHz. As shown in FIG. 5B, the second synchronization raster 510 may improve the likelihood of SSB detection in channels having narrow transmission bandwidths by providing or defining the additional synchronization raster points.

As indicated above, FIGS. 5A and 5B are provided as examples. Other examples may differ from what is described with respect to FIGS. 5A and 5B.

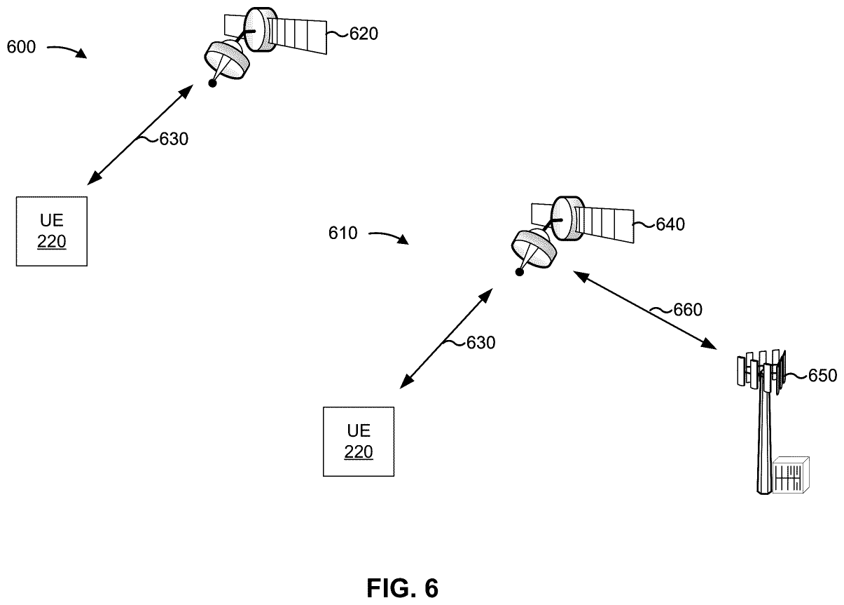

FIG. 6 is a diagram illustrating an example 600 of a regenerative satellite deployment and an example 610 of a transparent satellite deployment in a non-terrestrial network, in accordance with the present disclosure.

Example 600 shows a regenerative satellite deployment. In example 600, a UE 220 is served by a satellite 620 via a service link 630. For example, the satellite 620 may include a network node 210 (e.g., network node 210a) or a gNB. In some aspects, the satellite 620 may be referred to as a non-terrestrial base station, a regenerative repeater, or an on-board processing repeater. In some examples, the satellite 620 may demodulate an uplink radio frequency signal, and may modulate a baseband signal derived from the uplink radio signal to produce a downlink radio frequency transmission. The satellite 620 may transmit the downlink radio frequency signal on the service link 630. The satellite 620 may provide a cell that covers the UE 220.

Example 610 shows a transparent satellite deployment, which may also be referred to as a bent-pipe satellite deployment. In example 610, a UE 220 is served by a satellite 640 via the service link 630. The satellite 640 may be a transparent satellite. The satellite 640 may relay a signal received from gateway 650 via a feeder link 660. For example, the satellite may receive an uplink radio frequency transmission, and may transmit a downlink radio frequency transmission without demodulating the uplink radio frequency transmission. In some examples, the satellite may frequency convert the uplink radio frequency transmission received on the service link 630 to a frequency of the uplink radio frequency transmission on the feeder link 660, and may amplify and/or filter the uplink radio frequency transmission. In some examples, the UEs 220 shown in example 600 and example 610 may be associated with a GNSS capability or a Global Positioning System (GPS) capability, though not all UEs have such capabilities. The satellite 640 may provide a cell that covers the UE 220.

The service link 630 may include a link between the satellite 640 and the UE 220, and may include one or more of an uplink or a downlink. The feeder link 660 may include a link between the satellite 640 and the gateway 650, and may include one or more of an uplink (e.g., from the UE 220 to the gateway 650) or a downlink (e.g., from the gateway 650 to the UE 220).

The feeder link 660 and the service link 630 may each experience Doppler effects due to the movement of the satellites 620 and 640, and potentially movement of a UE 220. These Doppler effects may be significantly larger than in a terrestrial network. The Doppler effect on the feeder link 660 may be compensated for to some degree, but may still be associated with some amount of uncompensated frequency error. Furthermore, the gateway 650 may be associated with a residual frequency error, and/or the satellite 620 or the satellite 640 may be associated with an on-board frequency error. These sources of frequency error may cause a received downlink frequency at the UE 220 to drift from a target downlink frequency.

The frequency error or frequency drift of signals received by the UE 220 may result in ambiguity as to which synchronization raster point is observed or detected by the UE 220. For example, the frequency error (e.g., a Doppler shift) experienced by the UE 220 in NTN deployments may be in the order of 50 kHz or more. As described elsewhere herein, a frequency spacing between raster points of different frequency rasters may be as small as 100 kHz. As a result, the frequency error or frequency drift of synchronization signals received by the UE 220 may cause the UE 220 to incorrectly determine that a given synchronization raster point is observed or detected. As an example, a first cell (e.g., a first terrestrial network cell or a first NTN cell that uses a first synchronization raster, such as the first synchronization raster 500) and second cell (e.g., a second terrestrial network cell or a second NTN cell that uses a second synchronization raster, such as the second synchronization raster 510) are deployed or operate in overlapping frequencies in the same geographical area. The UE 220 may intend to search for the second cell or the first cell. However, because of the frequency error or frequency drift of synchronization signals received by the UE 220, the UE 220 may incorrectly select a raster point to scan or measure to access the intended cell (e.g., in some cases, raster points for the first cell and the second cell may be separated by 100 kHz and the UE 220 may experience frequency error or frequency drift on the order of 50 kHz, increasing the likelihood of the UE 220 selecting the wrong raster point to scan and/or measure). This may result in the UE 220 consuming power resources, network resources, and/or time resources, among other examples, associated with scanning, measuring, and/or attempting to access the wrong cell (e.g., an unintended cell). This may increase latency associated with the UE 220 accessing the intended cell.

Although examples may be described herein associated with NTN deployments resulting in frequency error or frequency drift of signals received by the UE 220, the UE 220 may similarly experience frequency error or frequency drift in other network deployments or scenarios. For example, the problems described herein may similarly occur in other high Doppler or high mobility scenarios (e.g., where the UE 220 or a network node 210 is moving at a high rate of speed), such as high-speed train scenarios, aircraft scenarios (e.g., where the UE 220 is located on, or is included in, an aircraft), maritime or naval scenarios, and/or UAV scenarios (e.g., where the UE 220 is located on, or is included in, a UAV or drone), among other examples.

As indicated above, FIG. 6 is provided as an example. Other examples may differ from what is described with regard to FIG. 6.

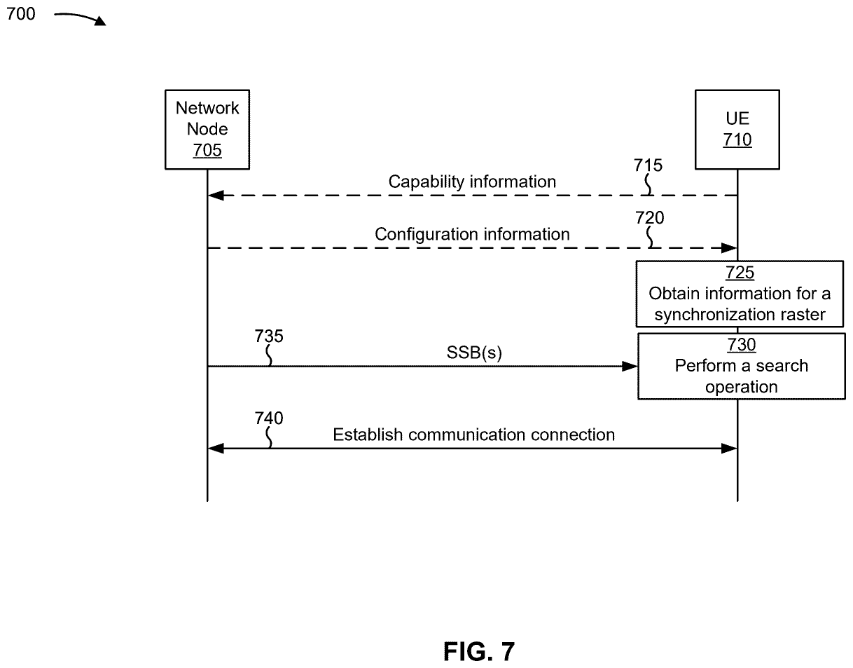

FIG. 7 is a diagram of an example 700 associated with a synchronization raster for channel co-existence, in accordance with the present disclosure. As shown in FIG. 7, a network node 705 (e.g., a network entity 102, a network entity 104, a network entity 106, a base station, a network node 210, a CU, a DU, and/or an RU) may communicate with a UE 710 (e.g., a network entity 102, a network entity 104, a network entity 106, and/or a UE 220). In some aspects, the network node 705 and the UE 710 may be part of a wireless network (e.g., the environment 100 and/or the wireless communication network 200).

In some aspects, the network node 705 may support a cell. The cell may be associated with high Doppler scenarios and/or high mobility scenarios. As an example, the cell may be an NTN cell (e.g., the network node 705 may be an NTN network node). In other aspects, the cell may be a terrestrial network cell (e.g., that is associated with high Doppler scenarios and/or high mobility scenarios). The network node 705 may use the synchronization raster described herein to transmit synchronization signals to improve channel co-existence, such as in the high Doppler scenarios and/or high mobility scenarios.

In some aspects, as shown by reference number 715, the UE 710 may optionally transmit capability information. The capability information may be included in a capability report. The UE 710 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a PSCCH, and/or a physical PSSCH, among other examples. The capability information may indicate one or more parameters associated with respective capabilities of the UE 710. The one or more parameters may be indicated via respective information elements (IEs) included in a capability report.

The capability information may indicate whether the UE 710 supports a feature and/or one or more parameters related to the feature. For example, the capability information may indicate a capability and/or parameter for supporting a synchronization raster described herein. As another example, the capability information may indicate a capability and/or parameter for supporting a synchronization raster that is associated with unequal frequency domain spacing between groups of raster points. As another example, the capability information may indicate a capability and/or parameter for supporting a synchronization raster that includes punctured raster points corresponding to raster point locations of another synchronization raster. One or more operations described herein may be based on capability information. For example, the UE may perform a communication in accordance with the capability information, or may receive configuration information that is in accordance with the capability information.

In some aspects, as shown by reference number 720, the network node 705 may transmit, and the UE 710 may receive, configuration information. In some aspects, the UE 710 may receive the configuration information via one or more of system information (e.g., a master information block (MIB) and/or a system information block (SIB), among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may at least partially be defined by a wireless communication standard, such as the 3GPP. In such examples, the network node 705 may not explicitly indicate the configuration information to the UE 710. For example, the UE 710 may obtain the configuration information from a configuration stored by the UE 710 (e.g., an original equipment manufacturer (OEM) configuration). In some aspects, the configuration information may include a parameter or index that is indicative of information defined, or otherwise fixed, by wireless communication standard, such as the 3GPP (e.g., rather than explicitly indicating the information).

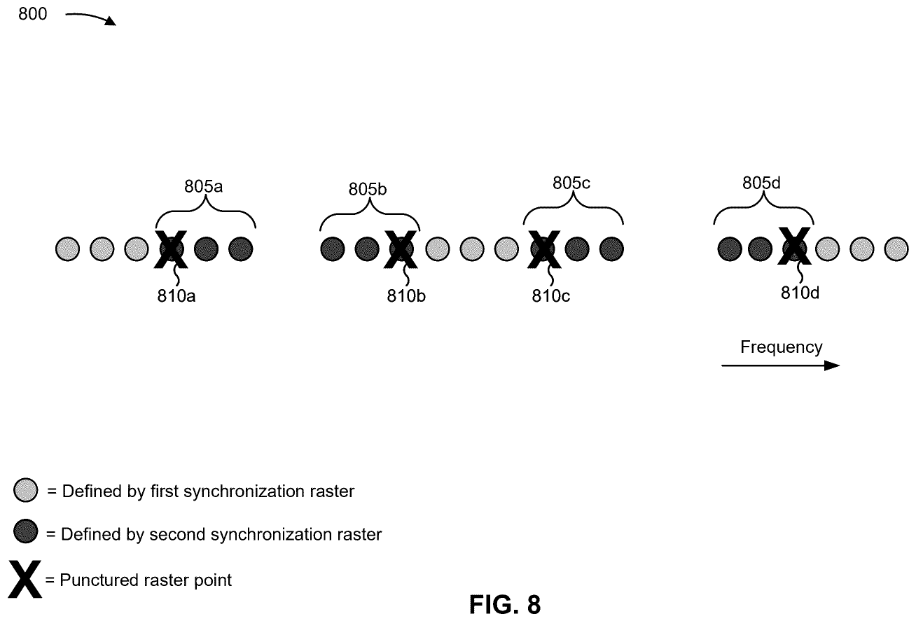

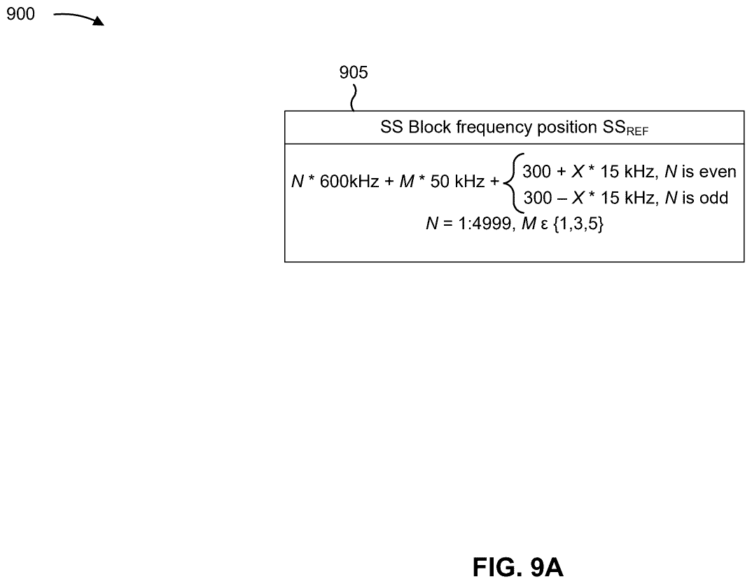

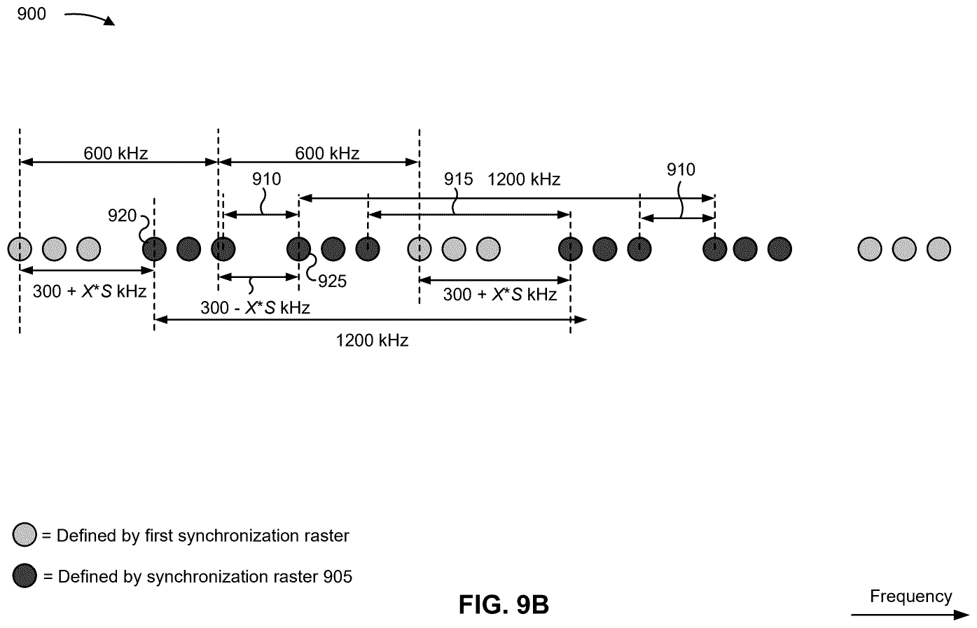

In some aspects, the configuration information may indicate that the UE 710 is to use (e.g., search or scan for SSBs in accordance with) a synchronization raster described herein. For example, the configuration information may indicate that the network node 705 is to transmit synchronization signals (e.g., SSBs) at one or more frequency domain locations in accordance with the synchronization raster described herein. As an example, the configuration information may indicate that the UE 710 is to use (e.g., search or scan for SSBs in accordance with) a synchronization signal having unequal frequency domain spacing between groups (e.g., clusters) of raster points (e.g., as depicted and described in more detail in connection with FIGS. 9A and 9B). Additionally, or alternatively, the configuration information may indicate that the UE 710 is to use (e.g., search or scan for SSBs in accordance with) a synchronization signal having one or more punctured raster points (e.g., as depicted and described in more detail in connection with FIG. 8). In some aspects, the configuration information may indicate that the synchronization raster is associated with a channel bandwidth of less than 5 MHz. For example, the configuration information may indicate that the synchronization raster is associated with a channel bandwidth of 3 MHZ.

In some aspects, the configuration information may indicate one or more parameters for the synchronization raster. For example, as described elsewhere herein, the synchronization raster may define raster points using one or more offset values. An offset value may be based on, or otherwise associated with, an integer value of a subcarrier size. The configuration information may indicate the integer value.

The UE 710 may configure itself based on the configuration information. In some aspects, the UE 710 may be configured to perform one or more operations described herein on the configuration information.

As shown by reference number 725, the UE 710 may obtain information for a synchronization raster (e.g., information indicative of the synchronization raster). The UE 710 may obtain the information via the configuration information and/or via information stored by the UE 710, such as in an OEM configuration. For example, the information for the synchronization raster may be defined, or otherwise fixed, by a wireless communication standard, such as the 3GPP.

In some aspects, the information for the synchronization raster may indicate that the synchronization raster includes one or more punctured raster points. For example, the synchronization raster may define a set of raster points and the information for the synchronization raster may indicate that one or more raster points from the set of raster points are to be punctured. The one or more punctured raster points defined by the synchronization raster may correspond to a different synchronization raster. For example, the different synchronization raster may be the first synchronization raster 500 described in connection with FIGS. 5A and 5B.

As an example, the one or more punctured raster points may correspond to the different synchronization raster in that the one or more punctured raster points may be the closest raster point(s) (e.g., in the frequency domain) to raster points of the different synchronization raster. For example, the information for the synchronization raster may indicate that one or more raster points in each group (or cluster) of raster points defined by the synchronization raster are to be punctured. As an example, the closest raster point (e.g., a single raster point) in each group of raster points to a raster point of the different synchronization raster may be punctured by the UE 710 (e.g., may not be scanned or monitored). By the UE 710 puncturing the one or more raster points, a frequency spacing between raster points of the two synchronization rasters is increased.

Additionally, or alternatively, the information for the synchronization raster may indicate that the synchronization raster is associated with an unequal frequency domain spacing between groups of raster points of the synchronization raster. For example, the synchronization raster may be associated with a first frequency domain spacing between a first set of groups of raster points and a second frequency domain spacing between a second set of groups of raster points. For example, a frequency spacing between a first group of raster points (e.g., associated with an even value of the parameter N) and a second group of raster points (e.g., associated with an odd value of the parameter N) may be different than the frequency spacing between the second group of raster points and a third group of raster points (e.g., a next group of raster points associated with an even value of the parameter N). The first set of groups of raster points are associated with even values of the parameter (e.g., N) associated with the synchronization raster and the second set of groups of raster points are associated with odd values of the parameter. The first group of raster points may be associated with a value of the parameter N of L (e.g., where L is an even value), the second group of raster points may be associated with a value of the parameter N of L+1, and the third group of raster points may be associated with a value of the parameter N of L+2.

A frequency spacing between consecutive set of groups of raster points having even values of the parameter N (e.g., between groups of raster points having the value L and L+2) may be the same as a frequency spacing between consecutive set of groups of raster points having odd values of the parameter N (e.g., between groups of raster points having the value L+1 and L+3). For example, the frequency spacing between groups of raster points having the value L and L+2 may be the same as the frequency spacing between groups of raster points having the value L+1 and L+3. However, there may be a first frequency spacing between the groups of raster points having the value L and L+1, a second frequency spacing between the groups of raster points having the value L+1 and L+2, and the first spacing between the groups of raster points having the value L+2 and L+3, and so on.

In some aspects, the unequal frequency domain spacing associated with the synchronization raster may be based on, or otherwise associated with, an integer value of a subcarrier size. For example, the subcarrier size may be 15 kHz or another size. An offset value used to determine a frequency domain location of a raster point may be modified by integer value (e.g., an integer factor) of a subcarrier size. For example, the unequal frequency domain spacing may be based on, or otherwise associated with a frequency step size and multiple offset values (e.g., a first offset value of even values of the parameter N and a second offset value for odd values of the parameter N). The frequency step size may be based on an equal frequency domain spacing between groups of raster points of a second synchronization raster (e.g., the second synchronization raster may be the first synchronization raster 500). For example, the frequency step size may half of the equal frequency domain spacing or another fraction (e.g., common fraction, simple fraction, or subunit) of the equal frequency domain spacing. The multiple offset values may be applicable to respective groups of raster points (e.g., groups of raster points associated with even values of the parameter N and groups of raster points associated with odd values of the parameter N). The multiple offset values may be based on an integer multiple of a subcarrier size. The unequal frequency domain spacing associated with the synchronization raster is depicted and described in more details in connection with FIGS. 9A and 9B.

As shown by reference number 730, the UE 710 may perform a search operation. For example, the search operation may be a cell search operation, an SSB search operation, or another search operation. For example, the UE 710 may perform the search operation as part of an initial access operation with the network node 705. The UE 710 may perform the search operation associated with a cell supported by the network node 705 (e.g., an NTN cell or another type of cell). The UE 710 may perform the search operation in accordance with the synchronization raster. For example, the UE 710 may identify raster points defined by the synchronization raster. The raster points may be indicative of candidate frequency domain locations for the synchronization signals associated with the cell (e.g., to be transmitted by the network node 705). The UE 710 may monitor the candidate frequency domain locations for SSB(s). In some aspects, the UE 710 may refrain from monitoring a candidate frequency domain location indicated by a punctured raster point of the synchronization raster. For example, the UE 710 may not expect an SSB to be transmitted at a candidate frequency domain location indicated by a punctured raster point of the synchronization raster.

In some aspects, a synchronization raster with equal frequency spacing (e.g. for channel bandwidth of 5 MHz or wider, such as the first synchronization raster 500) and a synchronization raster with unequal frequency spacing (e.g. for channel bandwidth less than 5 MHz) may be specified. In such examples, the UE 710 may obtain an indication of which bandwidth (e.g., which synchronization raster) is to be used to access a given cell. In such examples, the UE 120 may scan and/or monitor frequency domain locations defined by both synchronization rasters. The increased frequency spacing between raster points of the two synchronization rasters, as described in more detail elsewhere herein, may reduce the likelihood of the UE 120 incorrectly selecting or monitoring a raster point for a given synchronization raster (e.g., for a given cell or channel bandwidth).

As shown by reference number 735, the network node 705 may transmit one or more SSBs in accordance with the synchronization raster. For example, the network node 705 may transmit one or more SSBs at respective frequency domain locations indicated by raster points of the synchronization raster. The UE 710 may receive one or more SSBs based on, or associated with, performing the search operation. For example, the UE 710 may scan or monitor candidate frequency domain locations indicated by one or more raster points defined by the synchronization raster.

As shown by reference number 740, the UE 710 and the network node 705 may establish a communication connection. For example, the UE 710 may transmit, and the network node 705 may receive, one or more communications associated with the one or more SSBs. The one or more communications may be initial access communications, such as a communication associated with a RACH procedure. For example, the one or more SSBs may include random access configuration information. The one or more communications may include random access message (RAM), message A, msgA, a first message, a message 1, msg1, MSG1, or an initial message in a random access procedure. The UE 710 and the network node 705 may perform the random access procedure to establish the communication connection, such as an RRC connection.

As indicated above, FIG. 7 is provided as an example. Other examples may differ from what is described with respect to FIG. 7.

FIG. 8 is a diagram of an example 800 associated with a synchronization raster having punctured raster points, in accordance with the present disclosure. As shown in FIG. 8, a first synchronization raster may define a first set of raster points and a second synchronization raster may define a second set of raster points. The first synchronization raster may be the first synchronization raster 500. The second synchronization raster may be the synchronization raster used by the network node 705 and the UE 710 as described in connection with FIG. 7.

The second synchronization raster may be associated with one or more groups 805 of raster points (shown as group 805a, group 805b, group 805c, and group 805d in FIG. 8 as an example). As described elsewhere herein, the second synchronization raster may include one or more punctured raster points 810 (shown as a punctured raster point 810a, a punctured raster point 810b, a punctured raster point 810c, and a punctured raster point 810d in FIG. 8 as an example). For example, the second synchronization raster may define a set of raster points and one or more raster points from the set of raster points may be punctured. The one or more punctured raster points 810 may correspond to the first synchronization raster.

As an example, the one or more punctured raster points 810 may correspond to the first synchronization raster in that the one or more punctured raster points may be the closest raster point(s) (e.g., in the frequency domain) to raster points of the first synchronization raster. For example, one or more raster points in each group 805 (or cluster) of raster points defined by the synchronization raster are to be punctured. As an example, the closest raster point (e.g., a single raster point) in each group 805 of raster points to a raster point of the first synchronization raster may be punctured by the UE (e.g., may not be scanned or monitored). For example, a single raster point in each group 805 may be a punctured raster point. As an example, in the group 805a, the punctured raster point 810a may be a first raster point (e.g., first in the frequency domain) because the first raster point is closest to a raster point of the first synchronization raster (e.g., closest in the frequency domain among the raster points included in the group 805a). As another example, in the group 805b, the punctured raster point 810b may be a last raster point (e.g., last in the frequency domain) because the last raster point is closest to a raster point of the first synchronization raster (e.g., closest in the frequency domain among the raster points included in the group 805b). For example, in a given group 805, the punctured raster point 810 may be a first raster point or a last raster point in the frequency domain. For example, for groups 805 associated with an even value of the parameter N, the first raster point in the frequency domain may be the punctured raster point 810. For groups 805 associated with an odd value of the parameter N, the last raster point in the frequency domain may be the punctured raster point 810. By the UE puncturing the one or more raster points, a frequency spacing between raster points of the two synchronization rasters is increased.

As indicated above, FIG. 8 is provided as an example. Other examples may differ from what is described with respect to FIG. 8.

FIGS. 9A and 9B are diagrams of an example 900 associated with a synchronization raster having unequal frequency domain spacing, in accordance with the present disclosure.

As shown in FIG. 9A, a table may define one or more SSB frequency positions for a synchronization raster 905. The table may be defined, or otherwise fixed, by a wireless communication standard, such as the 3GPP. The synchronization raster 905 may be associated with unequal frequency domain spacing between groups of raster points of the synchronization raster 905. The synchronization raster 905 may be the synchronization raster used by the UE 710 and the network node 705 as described in connection with FIG. 7.

For example, the table associated with the synchronization raster 905 indicates GSCN parameters for a global frequency raster. The global synchronization raster may be defined for multiple (e.g., all) frequencies, and the frequency position of the SSB may be defined as S_{SREF}. As shown in the table associated with the synchronization raster 905, various parameters may define the S_{SREF} and GSCN for the multiple frequency ranges. The synchronization raster and the subcarrier spacing of the SSB may be defined separately for each band.

As shown, some frequency ranges (e.g., 0 to 3000 MHz), an SSB may be transmitted at one or more frequency positions within a frequency window (e.g., three potential frequency positions with 100 kHz spacing). The one or more frequency positions may be defined in accordance with Equation 1:

$${SS}_{REF} = N \times 600 kHz + M \times 50 kHz + \{ \begin{matrix}300 + X \times S kHz , & if N is even \\ 300 - X \times S kHz , & if N is odd\end{matrix} \} \qquad ( 1 )$$

N and M may be parameters associated with the synchronization raster 905, X may be an integer value, and S may be a subcarrier size (e.g., 15 kHz or another subcarrier size). N may range include values 1:4999 (e.g., to include frequencies associated with NTN deployments), and M may include values of 1, 3, and 5. As shown in Equation 1, the step size for the synchronization raster 905 may be 600 kHz. The step size may be based on a size of a frequency window for the first synchronization raster (e.g., the first synchronization raster 500). For example, the first synchronization raster may have a frequency window of 1200 kHz and the step size of the synchronization raster 905 may be half of the frequency window (e.g., 600 kHz) or another fraction of the frequency window.

The synchronization raster 905 may be associated with multiple offset values. The multiple offset values may include a first offset value to be applied if a value of the parameter N is even (e.g., 300+X×S kHz) and a second offset value to be applied if the value of the parameter N is odd (e.g., 300−X×S kHz). The multiple offset values may result in unequal frequency spacing between consecutive (e.g., consecutive in frequency) groups of raster points defined by the synchronization raster 905. As described elsewhere herein, the offset values may be defined by an integer factor or integer multiple (e.g., X) of a subcarrier size (e.g., S). A value of X may be indicated by a network node (e.g., in system information, such as a MIB or SIB) and/or may be defined by a wireless communication standard. In some aspects, the value of X may be the same for both even values of N and odd values of N. In other aspects, there may be a first value of X applicable when Nis an even value and a second value of X applicable when N is an odd value. In some aspects, such as when the first synchronization raster is the first synchronization raster 500, a value of X may be seven (e.g., if the subcarrier spacing is 15 kHz) to achieve optimal (e.g., a maximum) spacing between raster points of the first synchronization raster 500 and the synchronization aster 905.

As shown in FIG. 9B, a frequency domain spacing between a group of raster points defined by the first synchronization raster and a group of raster points defined by the synchronization raster 905 may be based on the offset of either 300+X×S kHz (e.g., if the value of Nis even) or 300−X×S kHz (e.g., if the value of Nis odd). This results in a first frequency spacing 910 from a first group of raster points defined by an even value of N and a second group of raster points defined by an odd value of N. Additionally, this results in a second frequency spacing 915 from the second group of raster points defined by the odd value of N and a third group of raster points defined by another even value of N. The first frequency spacing 910 and the second frequency spacing 915 may be different values or different sizes. For example, if the value of X is seven and the subcarrier spacing is 15 kHz, then the first frequency spacing 910 may be 190 kHz and the second frequency spacing 915 may be 610 kHz. For example, assuming a reference frequency of 0 kHz (e.g., the first raster point of the first synchronization raster shown in FIG. 9B being at 0 kHz (e.g., N*600 kHz+M*50 KHz=0 kHz for the first raster point of the first synchronization raster) for case of explanation), a raster point 920 (e.g., of a group of raster points having a value of N=0) may be placed at a frequency of 405 kHz (e.g., where M=1), the next raster point at 505 kHz (e.g., where M=3), and a last raster point of that group of raster points at 605 kHz e.g., where M=1). A raster point 925 (e.g., of a group of raster points having a value of N of 1) may be placed at a frequency of 795 kHz, a next raster point may be placed at a frequency of 895 kHz, and a last raster point of that group of raster points may be placed at a frequency of 995 kHz. This results in a frequency spacing of 190 kHz between the last raster point of the group defined by N=0 and the raster point 925 (e.g., 795 kHz−605 kHz=190 kHz). This increases the frequency spacing between the raster point 920 and the last raster point of the first group of raster points defined by the first synchronization raster (e.g., which may now be 205 kHz (e.g., 405 kHz-200 kHz) in this example, rather than 100 kHz as depicted in FIG. 5B). This also increases the frequency spacing between the last raster point in the group of raster points defined by N=1 for the synchronization raster 905 and a first raster point of a second group of raster points defined by the first synchronization raster (e.g., which may now be 205 kHz (e.g., 1200 kHz-995 kHz) in this example, rather than 100 kHz as depicted in FIG. 5B).

As shown in FIG. 9B, a frequency spacing between groups of raster points defined by an even value of N and a frequency spacing between groups of raster points defined by an odd value of N may be equal (e.g., 1200 kHz and shown in FIG. 9B). In other words, a frequency spacing between every two groups of raster points defined by the synchronization raster 905 may have the same value (e.g., 1200 kHz as an example shown in FIG. 9B).

The unequal frequency spacing may increase the frequency spacing between raster points defined by the first synchronization raster and raster points defined by the synchronization raster 905. For example, as shown in FIG. 9B, a frequency spacing between a group of raster points defined by the first synchronization raster and raster points defined by the synchronization raster 905 may be based on the offset of either 300+X×S kHz (e.g., if the value of N is even) or 300−X×S kHz (e.g., if the value of N is odd). For example, as shown in FIG. 9B, for a first group of raster points defined by an even value of N (e.g., starting at the raster point 920 shown in FIG. 9B), the raster point 920 (e.g., having a value of M of 1) may be offset from a reference frequency (e.g., at an increment of 600 kHz defined by N) by 300+X×S kHz. For a next group of raster points defined by an odd value of N (e.g., starting at the raster point 925 shown in FIG. 9B), the raster point 925 (e.g., having a value of M of 1) may be offset from ((N+1)*600 kHz) by 300−X×S kHz. This results in the different frequency spacings (e.g., the first frequency spacing 910 and the second frequency spacing 915) between groups of raster points defined by the synchronization raster 905. For some values of X and S, this results in a minimum frequency spacing of greater than 100 kHz between a raster points defined by the different synchronization rasters. This improves channel co-existence when there are cells using the first synchronization raster and the synchronization raster 905 on overlapping frequency ranges and in the same (or similar) geographic area. The increased frequency spacing may reduce the likelihood of a UE misdetecting an SSB for a given cell, thereby improving the likelihood that the UE is able to receive the SSB from an intended cell and/or decreasing the latency for initial access with the cell.

As indicated above, FIGS. 9A and 9B are provided as examples. Other examples may differ from what is described with respect to FIGS. 9A and 9B.

FIG. 10 is a diagram illustrating an example process 1000 performed, for example, at a network entity or an apparatus of a network entity, in accordance with the present disclosure. Example process 1000 is an example where the apparatus or the network entity (e.g., network entity 102, network entity 104, network entity 106, UE 220, and/or UE 710) performs operations associated with synchronization raster for channel co-existence.

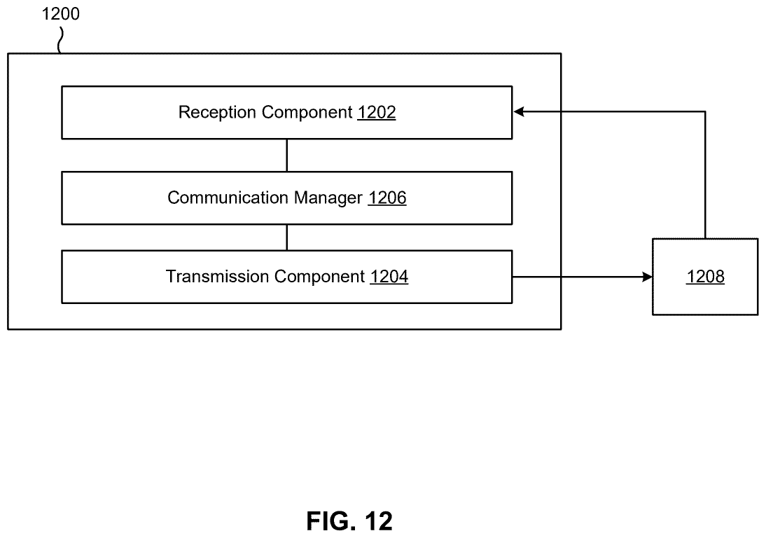

As shown in FIG. 10, in some aspects, process 1000 may include performing, in accordance with a synchronization raster, a search operation associated with a cell, wherein the synchronization raster indicates an unequal frequency domain spacing between groups of raster points of the synchronization raster (block 1010). For example, the network entity (e.g., using communication manager 1206, depicted in FIG. 12) may perform, in accordance with a synchronization raster, a search operation associated with a cell, wherein the synchronization raster indicates an unequal frequency domain spacing between groups of raster points of the synchronization raster, as described above.

As further shown in FIG. 10, in some aspects, process 1000 may include receiving, based on the search operation, one or more SSBs associated with the cell (block 1020). For example, the network entity (e.g., using reception component 1202 and/or communication manager 1206, depicted in FIG. 12) may receive, based on the search operation, one or more SSBs associated with the cell, as described above.

Process 1000 may include additional aspects, such as any single aspect or any combination of aspects described below and/or in connection with one or more other processes described elsewhere herein.

In a first aspect, the synchronization raster is associated with a first frequency domain spacing between a first set of groups of raster points and a second frequency domain spacing between a second set of groups of raster points.

In a second aspect, alone or in combination with the first aspect, the first set of groups of raster points are associated with even values of a parameter associated with the synchronization raster and the second set of groups of raster points are associated with odd values of the parameter.

In a third aspect, alone or in combination with one or more of the first and second aspects, the unequal frequency domain spacing is based on an integer value of a subcarrier size.

In a fourth aspect, alone or in combination with one or more of the first through third aspects, the unequal frequency domain spacing is based on a frequency step size and multiple offset values, wherein the multiple offset values are applicable to respective groups of raster points.

In a fifth aspect, alone or in combination with one or more of the first through fourth aspects, the synchronization raster is a first synchronization raster, and the frequency step size is based on an equal frequency domain spacing between groups of raster points of a second synchronization raster.

In a sixth aspect, alone or in combination with one or more of the first through fifth aspects, the multiple offset values are based on an integer multiple of a subcarrier size.

In a seventh aspect, alone or in combination with one or more of the first through sixth aspects, the cell is a non-terrestrial network cell.

In an eighth aspect, alone or in combination with one or more of the first through seventh aspects, the synchronization raster is associated with a channel bandwidth of less than 5 megahertz.

In a ninth aspect, alone or in combination with one or more of the first through eighth aspects, receiving the one or more SSBs comprises receiving the one or more SSBs using frequency domain resources indicated by the synchronization raster.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network entity or an apparatus of a network entity, in accordance with the present disclosure. Example process 1100 is an example where the apparatus or the network entity (e.g., network entity 102, network entity 104, network entity 106, network node 210, and/or network node 705) performs operations associated with synchronization raster for channel co-existence.

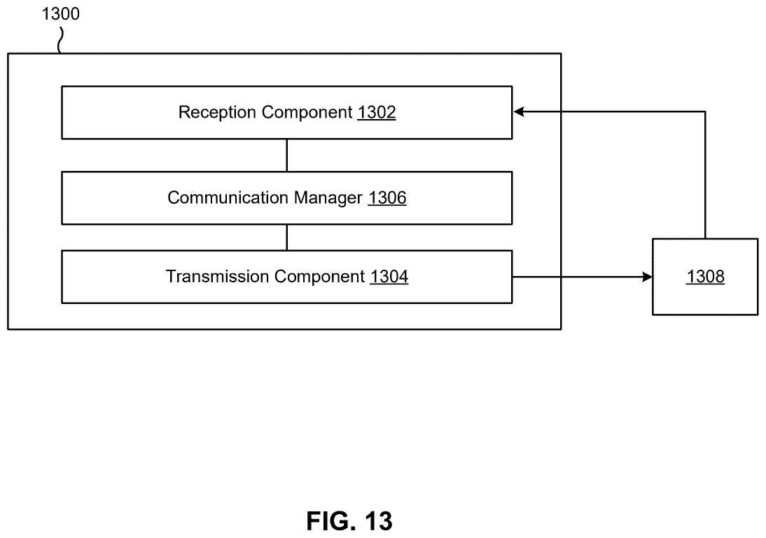

As shown in FIG. 11, in some aspects, process 1100 may include transmitting, in accordance with a synchronization raster, one or more SSBs associated with a cell, wherein the synchronization raster indicates an unequal frequency domain spacing between groups of raster points of the synchronization raster (block 1110). For example, the network entity (e.g., using transmission component 1304 and/or communication manager 1306, depicted in FIG. 13) may transmit, in accordance with a synchronization raster, one or more SSBs associated with a cell, wherein the synchronization raster indicates an unequal frequency domain spacing between groups of raster points of the synchronization raster, as described above.

As further shown in FIG. 11, in some aspects, process 1100 may include receiving one or more communications associated with the one or more SSBs (block 1120). For example, the network entity (e.g., using reception component 1302 and/or communication manager 1306, depicted in FIG. 13) may receive one or more communications associated with the one or more SSBs, as described above.

Process 1100 may include additional aspects, such as any single aspect or any combination of aspects described below and/or in connection with one or more other processes described elsewhere herein.

In a first aspect, the synchronization raster is associated with a first frequency domain spacing between a first set of groups of raster points and a second frequency domain spacing between a second set of groups of raster points.

In a second aspect, alone or in combination with the first aspect, the first set of groups of raster points are associated with even values of a parameter associated with the synchronization raster and the second set of groups of raster points are associated with odd values of the parameter.

In a third aspect, alone or in combination with one or more of the first and second aspects, the unequal frequency domain spacing is based on an integer value of a subcarrier size.

In a fourth aspect, alone or in combination with one or more of the first through third aspects, the unequal frequency domain spacing is based on a frequency step size and multiple offset values, and the multiple offset values are applicable to respective groups of raster points.

In a fifth aspect, alone or in combination with one or more of the first through fourth aspects, the synchronization raster is a first synchronization raster, and the frequency step size is based on an equal frequency domain spacing between groups of raster points of a second synchronization raster.

In a sixth aspect, alone or in combination with one or more of the first through fifth aspects, the multiple offset values are based on an integer multiple of a subcarrier size.

In a seventh aspect, alone or in combination with one or more of the first through sixth aspects, the cell is a non-terrestrial network cell.

In an eighth aspect, alone or in combination with one or more of the first through seventh aspects, the synchronization raster is associated with a channel bandwidth of less than 5 megahertz.

In a ninth aspect, alone or in combination with one or more of the first through eighth aspects, transmitting the one or more SSBs comprises transmitting the one or more SSBs using frequency domain resources indicated by the synchronization raster.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network entity, or a network entity may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 114, the communication manager 118, and/or the communication manager 240. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7, 8, 9A, and 9B. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network entity, UE, or network node described in connection with FIGS. 1-3. Additionally, or alternatively, one or more components shown in FIG. 12 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network entity, UE, or network node described in connection with FIGS. 1-3.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network entity, UE, or network node described in connection with FIGS. 1-3. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may perform, in accordance with a synchronization raster, a search operation associated with a cell, wherein the synchronization raster indicates an unequal frequency domain spacing between groups of raster points of the synchronization raster. The reception component 1202 may receive, based on the search operation, one or more SSBs associated with the cell.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity, or a network entity may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 114, the communication manager 118, and/or the communication manager 250. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7, 8, 9A, and 9B. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network entity, UE, or network node described in connection with FIGS. 1-3. Additionally, or alternatively, one or more components shown in FIG. 13 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network entity, UE, or network node described in connection with FIGS. 1-3.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network entity, UE, or network node described in connection with FIGS. 1-3. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, in accordance with a synchronization raster, one or more SSBs associated with a cell, wherein the synchronization raster indicates an unequal frequency domain spacing between groups of raster points of the synchronization raster. The reception component 1302 may receive one or more communications associated with the one or more SSBs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a network entity, comprising: performing, in accordance with a synchronization raster, a search operation associated with a cell, wherein the synchronization raster indicates an unequal frequency domain spacing between groups of raster points of the synchronization raster; and receiving, based on the search operation, one or more synchronization signal blocks (SSBs) associated with the cell.

Aspect 2: The method of Aspect 1, wherein the synchronization raster is associated with a first frequency domain spacing between a first set of groups of raster points and a second frequency domain spacing between a second set of groups of raster points.

Aspect 3: The method of Aspect 2, wherein the first set of groups of raster points are associated with even values of a parameter associated with the synchronization raster and the second set of groups of raster points are associated with odd values of the parameter.

Aspect 4: The method of any of Aspects 1-3, wherein the unequal frequency domain spacing is based on an integer value of a subcarrier size.

Aspect 5: The method of any of Aspects 1-4, wherein the unequal frequency domain spacing is based on a frequency step size and multiple offset values, wherein the multiple offset values are applicable to respective groups of raster points.

Aspect 6: The method of Aspect 5, wherein the synchronization raster is a first synchronization raster, and wherein the frequency step size is based on an equal frequency domain spacing between groups of raster points of a second synchronization raster.

Aspect 7: The method of Aspect 5, wherein the multiple offset values are based on an integer multiple of a subcarrier size.

Aspect 8: The method of any of Aspects 1-7, wherein the cell is a non-terrestrial network cell.

Aspect 9: The method of any of Aspects 1-8, wherein the synchronization raster is associated with a channel bandwidth of less than 5 megahertz.

Aspect 10: The method of any of Aspects 1-9, wherein receiving the one or more SSBs comprises: receiving the one or more SSBs using frequency domain resources indicated by the synchronization raster.

Aspect 11: A method of wireless communication performed by a network entity, comprising: transmitting, in accordance with a synchronization raster, one or more synchronization signal blocks (SSBs) associated with a cell, wherein the synchronization raster indicates an unequal frequency domain spacing between groups of raster points of the synchronization raster; and receiving one or more communications associated with the one or more SSBs.

Aspect 12: The method of Aspect 11, wherein the synchronization raster is associated with a first frequency domain spacing between a first set of groups of raster points and a second frequency domain spacing between a second set of groups of raster points.

Aspect 13: The method of Aspect 12, wherein the first set of groups of raster points are associated with even values of a parameter associated with the synchronization raster and the second set of groups of raster points are associated with odd values of the parameter.

Aspect 14: The method of any of Aspects 11-13, wherein the unequal frequency domain spacing is based on an integer value of a subcarrier size.

Aspect 15: The method of any of Aspects 11-14, wherein the unequal frequency domain spacing is based on a frequency step size and multiple offset values, wherein the multiple offset values are applicable to respective groups of raster points.

Aspect 16: The method of Aspect 15, wherein the synchronization raster is a first synchronization raster, and wherein the frequency step size is based on an equal frequency domain spacing between groups of raster points of a second synchronization raster.

Aspect 17: The method of Aspect 15, wherein the multiple offset values are based on an integer multiple of a subcarrier size.

Aspect 18: The method of any of Aspects 11-17, wherein the cell is a non-terrestrial network cell.

Aspect 19: The method of any of Aspects 11-18, wherein the synchronization raster is associated with a channel bandwidth of less than 5 megahertz.

Aspect 20: The method of any of Aspects 11-19, wherein transmitting the one or more SSBs comprises: transmitting the one or more SSBs using frequency domain resources indicated by the synchronization raster.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Further, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A network entity, comprising:
a processing system configured to:
perform, in accordance with a synchronization raster, a search operation associated with a cell, wherein the synchronization raster indicates an unequal frequency domain spacing between groups of raster points of the synchronization raster; and
receive, based on the search operation, one or more synchronization signal blocks (SSBs) associated with the cell.

2. The network entity of claim 1, wherein the synchronization raster is associated with a first frequency domain spacing between a first set of groups of raster points and a second frequency domain spacing between a second set of groups of raster points.

3. The network entity of claim 2, wherein the first set of groups of raster points are associated with even values of a parameter associated with the synchronization raster and the second set of groups of raster points are associated with odd values of the parameter.

4. The network entity of claim 1, wherein the unequal frequency domain spacing is based on an integer value of a subcarrier size.

5. The network entity of claim 1, wherein the unequal frequency domain spacing is based on a frequency step size and multiple offset values, wherein the multiple offset values are applicable to respective groups of raster points.

6. The network entity of claim 5, wherein the synchronization raster is a first synchronization raster, and wherein the frequency step size is based on an equal frequency domain spacing between groups of raster points of a second synchronization raster.

7. The network entity of claim 5, wherein the multiple offset values are based on an integer multiple of a subcarrier size.

8. A network entity, comprising:
a processing system configured to:
transmit, in accordance with a synchronization raster, one or more synchronization signal blocks (SSBs) associated with a cell, wherein the synchronization raster indicates an unequal frequency domain spacing between groups of raster points of the synchronization raster; and
receive one or more communications associated with the one or more SSBs.

9. The network entity of claim 8, wherein the synchronization raster is associated with a first frequency domain spacing between a first set of groups of raster points and a second frequency domain spacing between a second set of groups of raster points.

10. The network entity of claim 9, wherein the first set of groups of raster points are associated with even values of a parameter associated with the synchronization raster and the second set of groups of raster points are associated with odd values of the parameter.

11. The network entity of claim 8, wherein the unequal frequency domain spacing is based on an integer value of a subcarrier size.

12. The network entity of claim 8, wherein the unequal frequency domain spacing is based on a frequency step size and multiple offset values, wherein the multiple offset values are applicable to respective groups of raster points.

13. The network entity of claim 12, wherein the synchronization raster is a first synchronization raster, and wherein the frequency step size is based on an equal frequency domain spacing between groups of raster points of a second synchronization raster.

14. The network entity of claim 12, wherein the multiple offset values are based on an integer multiple of a subcarrier size.

15. The network entity of claim 8, wherein the processing system, to transmit the one or more SSBs, is configured to:
transmit the one or more SSBs using frequency domain resources indicated by the synchronization raster.

16. A method of wireless communication performed by a network entity, comprising:
performing, in accordance with a synchronization raster, a search operation associated with a cell, wherein the synchronization raster indicates an unequal frequency domain spacing between groups of raster points of the synchronization raster; and
receiving, based on the search operation, one or more synchronization signal blocks (SSBs) associated with the cell.

17. The method of claim 16, wherein the synchronization raster is associated with a first frequency domain spacing between a first set of groups of raster points and a second frequency domain spacing between a second set of groups of raster points.

18. The method of claim 17, wherein the first set of groups of raster points are associated with even values of a parameter associated with the synchronization raster and the second set of groups of raster points are associated with odd values of the parameter.

19. The method of claim 16, wherein the unequal frequency domain spacing is based on an integer value of a subcarrier size.

20. The method of claim 16, wherein the unequal frequency domain spacing is based on a frequency step size and multiple offset values, wherein the multiple offset values are applicable to respective groups of raster points.
